(19) United States
(12) Patent Application Publication
(10) Pub. No.: US 2022/0148110 A1
(43) Pub. Date: May 12, 2022

(54) CONTROL METHOD, SERVER, AND RECORDING MEDIUM

(71) Applicant: Panasonic Intellectual Property Corporation of America, Torrance, CA (US)

(72) Inventors: Yuji UNAGAMI, Osaka (JP); Junji MICHIYAMA, Fukuoka (JP); Junichiro SOEDA, Nara (JP); Naohisa NISHIDA, Osaka (JP); Yuuki HIROSE, Osaka (JP); Tetsuji FUCHIKAMI, Osaka (JP); Motoji OHMORI, Osaka (JP)

(21) Appl. No.: 17/581,225

(22) Filed: Jan. 21, 2022

Related U.S. Application Data
(63) Continuation of application No. PCT/JP2020/028946, filed on Jul. 28, 2020.
(60) Provisional application No. 62/881,609, filed on Aug. 1, 2019.

(51) Int. Cl. G06Q 50/18; G06Q 20/38

(52) U.S. Cl. CPC G06Q 50/18; G06Q 20/389

(57) ABSTRACT

First information including first contract information indicating contract content of a first contract and a provisional contract flag indicating that the first contract information is a provisional contract is received from a first terminal used by a first user who is one of two parties that have agreed to the first contract, and is stored into a ledger. The first contract information obtained from the ledger is transmitted to a second terminal used by an auditor who inspects the first contract information. A check result indicating approval or disapproval of the first contract information by the auditor is received from the second terminal. When the check result indicates approval of the first contract information, second information including the first contract information and a definitive contract flag indicating that the first contract information has been adopted as a definitive contract is obtained and stored into the ledger.

### CROSS REFERENCE TO RELATED APPLICATIONS

This is a continuation application of PCT International Application No. PCT/JP2020/028946 filed on Jul. 28, 2020, designating the United States of America, which is based on and claims priority of U.S. Provisional Patent Application No. 62/881,609 filed on Aug. 1, 2019. The entire disclosures of the above-identified applications, including the specifications, drawings and claims are incorporated herein by reference in their entirety.

### FIELD

The present disclosure relates to control methods, servers, and recording media.

### BACKGROUND

For example, Patent Literature (PTL) 1 discloses a method for assessing the maximum current-carrying capacity required for usage by each user and determining a contract electric current according to the assessed maximum current-carrying capacity.

### CITATION LIST

### Patent Literature

PTL 1: Japanese Unexamined Patent Publication Application No. 2002-159138

### SUMMARY

### Technical Problem

However, the method disclosed in PTL 1, in which a supplier such as an electric power company and each user have an individual contract, has the problem of being unable to reduce the cases in which the supplier and one user collude with each other and conclude a contract that is not fair for other users.

For example, assume that in a housing complex such as a condominium, a user of each unit and an electric power company have an individual contract. In this case, the electric power company and one user may collude with each other and conclude a contract including preferential treatment as compared to contracts with other users, for example, to increase the power allocation to only the home of said user or reduce the per kilowatt charge on only the home of said user. Even when the contract of each unit of the housing complex is managed in such a form that the content of the contract is viewable by anyone in the housing complex, there is no guarantee that a user of each unit bothers to check contracts with other users to make sure that those are fair contracts. This means that in the case where a supplier and each user conclude an individual contract, it is not possible to reduce the cases in which an electric power company and one user collude with each other and conclude a contract including preferential treatment.

Furthermore, for example, assume that in car sharing services involving automobiles, a service supplier and each user who uses the service conclude an individual contract. In this case as well, the service supplier and one user may collude with each other and conclude a contract including preferential treatment as compared to contracts with other users, for example, to increase the amount of sharing time for only said user at the same price as other users. In such a case, even if the contract with each user who uses the service is managed in such a form that the content of the contract is viewable by any users, there is no guarantee that each user bothers to check contracts with other users to make sure that those are fair contracts, as in the case mentioned above. This means that in the case where a service supplier and each user conclude an individual contract, it is not possible to reduce the cases in which the service supplier and one user collude with each other and conclude a contract including preferential treatment.

The present disclosure is conceived in view of the above-described circumstances and has an object to provide a control method, a server, and a recording medium by which newly concluded contracts can be more reliably subject to inspection.

### Solution to Problem

According to an exemplary embodiment disclosed herein, a control method to be performed by a first server among one or more servers in a system including the one or more servers and three or more terminals each used by a user includes: receiving first information including first contract information and a provisional contract flag from a first terminal, the first contract information indicating contract content of a first contract, the provisional contract flag indicating that the first contract information is a provisional contract, the first terminal being used by a first user who is one of two parties that have agreed to the first contract; storing, into a ledger, the first information received; transmitting, to a second terminal used by an auditor who inspects the first contract information, the first contract information obtained from the ledger;

receiving, from the second terminal, a check result indicating approval or disapproval of the first contract information by the auditor; and checking the check result, and when the check result indicates the approval of the first contract information, obtaining second information including the first contract information and a definitive contract flag, and storing the second information into the ledger, the definitive contract flag indicating that the first contract information has been adopted as a definitive contract.

Note that these general and specific aspects may be implemented using a system, a method, an integrated circuit, a computer program, or a computer-readable recording medium such as a compact disc read-only memory (CD-ROM), or any combination of systems, methods, integrated circuits, computer programs, and recording media.

### Advantageous Effects

According to the present disclosure, newly concluded contracts can be more reliably subject to inspection.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating one example of the configuration of a management system according to Embodiment 1.

FIG. 2 is a diagram illustrating one example of the configuration of a supplier terminal according to Embodiment 1.

FIG. 3 is a diagram illustrating one example of the configuration of a terminal according to Embodiment 1.

FIG. 4 is a diagram illustrating one example of the configuration of an authentication server according to Embodiment 1.

FIG. 5 is a diagram illustrating one example of a management contact list according to Embodiment 1.

FIG. 6 is a sequence diagram illustrating the operation of a management system according to Embodiment 1.

FIG. 7 is a sequence diagram illustrating the operation of a management system according to Embodiment 1.

FIG. 8 is a sequence diagram illustrating the operation of a management system according to Embodiment 1.

FIG. 9 is a diagram illustrating one example of the configuration of a management system according to Embodiment 2.

FIG. 10 is a diagram illustrating one example of the configuration of a supplier terminal according to Embodiment 2.

FIG. 11 is a diagram illustrating one example of the configuration of an authentication server according to Embodiment 2.

FIG. 12 is a sequence diagram illustrating the operation of a management system according to Embodiment 2.

FIG. 13 is a sequence diagram illustrating the operation of a management system according to Embodiment 2.

FIG. 14 is a sequence diagram illustrating the operation of a management system according to Embodiment 2.

FIG. 15 is a sequence diagram illustrating the operation of a management system according to a variation of Embodiment 2.

FIG. 16 is a diagram illustrating one example of the configuration of a management system according to Embodiment 3.

FIG. 17 is a diagram illustrating one example of the configuration of a supplier terminal according to Embodiment 3.

FIG. 18 is a diagram illustrating one example of the configuration of a terminal according to Embodiment 3.

FIG. 19 is a sequence diagram illustrating the operation of a management system according to Embodiment 3.

FIG. 20 is a sequence diagram illustrating the operation of a management system according to Embodiment 3.

FIG. 21 is a sequence diagram illustrating the operation of a management system according to Embodiment 3.

FIG. 22 is a diagram illustrating one example of the configuration of a management system according to Variation 1 of Embodiment 3.

FIG. 23 is a diagram illustrating one example of the configuration of an agent server according to Variation 1 of Embodiment 3.

FIG. 24 is a sequence diagram illustrating the operation of a management system according to Variation 1 of Embodiment 3.

FIG. 25 is a sequence diagram illustrating the operation of a management system according to Variation 1 of Embodiment 3.

FIG. 26 is a sequence diagram illustrating the operation of a management system according to Variation 1 of Embodiment 3.

FIG. 27 is a diagram illustrating one example of the configuration of a management system according to Variation 2 of Embodiment 3.

FIG. 28 is a diagram illustrating one example of the configuration of an authentication server according to Variation 2 of Embodiment 3.

FIG. 29 is a sequence diagram illustrating the operation of a management system according to Variation 2 of Embodiment 3.

FIG. 30 is a sequence diagram illustrating the operation of a management system according to Variation 2 of Embodiment 3.

FIG. 31 is a sequence diagram illustrating the operation of a management system according to Variation 2 of Embodiment 3.

### DESCRIPTION OF EMBODIMENTS

According to an exemplary embodiment disclosed herein, a control method to be performed by a first server among one or more servers in a system including the one or more servers and three or more terminals each used by a user includes: receiving first information including first contract information and a provisional contract flag from a first terminal, the first contract information indicating contract content of a first contract, the provisional contract flag indicating that the first contract information is a provisional contract, the first terminal being used by a first user who is one of two parties that have agreed to the first contract; storing, into a ledger, the first information received; transmitting, to a second terminal used by an auditor who inspects the first contract information, the first contract information obtained from the ledger; receiving, from the second terminal, a check result indicating approval or disapproval of the first contract information by the auditor; and checking the check result, and when the check result indicates the approval of the first contract information, obtaining second information including the first contract information and a definitive contract flag, and storing the second information into the ledger, the definitive contract flag indicating that the first contract information has been adopted as a definitive contract.

In this manner, the contract document of the newly concluded contract is subject to inspection by the auditor, and thus the newly concluded contract can be reliably subject to inspection. Furthermore, because the newly concluded contract can be reliably subject to inspection, it is possible to keep the supplier and the user from concluding a contract in collusion.

Furthermore, for example, in the control method, the transmitting of the first contract information obtained from the ledger may include: determining, at a predetermined timing, the auditor who inspects the first contract information; and transmitting, to the second terminal used by the auditor determined, the first contract information obtained from the ledger.

Furthermore, for example, in the control method, the ledger may be a distributed ledger built on a blockchain platform and composed of a plurality of ledgers including identical content. With this, a contract that has come into effect is stored into the distributed ledger, and therefore it is possible to prevent future tampering with the newly concluded definitive contract. Thus, it is also possible to keep the supplier and the user from tampering with the contract in collusion in the future.

Furthermore, for example, in the control method, the receiving of the first information may include: receiving first transaction data including the first information to receive the first information, the storing of the first information received, into the ledger, may include: storing, into the ledger, a block including the first transaction data, the obtaining of the second information may include: obtaining second transaction data including the second information to obtain the second information, and the storing of the second information obtained, into the ledger, may include: storing, into the ledger, a block including the second transaction data.

Furthermore, for example, in the control method, the storing of the block including the first transaction data or the second transaction data into the ledger may include: executing, along with a plurality of second servers among the one or more servers except the first server, a consensus algorithm for approving validity of the first transaction data or the second transaction data; and storing, into the ledger, the block including the first transaction data or the second transaction data when the validity of the first transaction data or the second transaction data is approved by the consensus algorithm.

Furthermore, for example, in the control method, the storing of the block including the first transaction data or the second transaction data into the ledger may include: storing the first transaction data or the second transaction data into the ledger as blockchain transaction data.

Furthermore, for example, in the control method, the first information may include: in addition to the first contract information and the provisional contract flag, time information; an ID indicating a second user who is an other of the two parties that have agreed to the first contract; and a signature of a person who has generated the first information.

According to an exemplary embodiment disclosed herein, a server that is one of one or more servers in a system including the one or more servers and three or more terminals each used by a user includes: a processor; and memory. The processor receives, from a first terminal used by a first user who is one of two parties that have agreed to first contract, first information including: first contract information indicating contract content of the first contract; and a provisional contract flag indicating that the first contract information is a provisional contract. The processor stores, into a ledger, the first information received. The processor transmits, to a second terminal used by an auditor who inspects the first contract information, the first contract information obtained from the ledger. The processor receives, from the second terminal, a check result indicating approval or disapproval of the first contract information by the auditor. The processor checks the check result, and when the check result indicates the approval of the first contract information, obtains second information including the first contract information and a definitive contract flag indicating that the first contract information has been adopted as a definitive contract, and stores the second information into the ledger, the definitive contract flag.

According to an exemplary embodiment disclosed herein, a non-transitory computer-readable recording medium has recorded thereon a program for causing a computer to execute a control method to be performed by a first server among one or more servers in a system including the one or more servers and three or more terminals each used by a user. The computer executes: receiving first information including first contract information and a provisional contract flag from a first terminal, the first contract information indicating contract content of a first contract, the provisional contract flag indicating that the first contract information is a provisional contract, the first terminal being used by a first user who is one of two parties that have agreed to the first contract; storing, into a ledger, the first information received; transmitting, to a second terminal used by an auditor who inspects the first contract information, the first contract information obtained from the ledger; receiving, from the second terminal, a check result indicating approval or disapproval of the first contract information by the auditor; and checking the check result, and when the check result indicates the approval of the first contract information, obtaining second information including the first contract information and a definitive contract flag, and storing the second information into the ledger, the definitive contract flag indicating that the first contract information has been adopted as a definitive contract.

Hereinafter, exemplary embodiments are described with reference to the Drawings. Note that each of the exemplary embodiments described below shows a specific example of the present disclosure. The numerical values, shapes, materials, structural elements, the arrangement and connection of the structural elements, steps, the processing order of the steps etc. shown in the following exemplary embodiments are mere examples, and therefore are not intended to limit the present disclosure. Thus, among the structural elements in the following exemplary embodiments, those not recited in any one of the independent claims which indicate the broadest concepts of the present disclosure are described as structural elements that are not necessarily required to achieve the object of the present disclosure, but are included in a more preferable exemplary embodiment.

### Embodiment 1

First, the system configuration according to the present disclosure will be described.

A management system according to the present disclosure includes: three or more terminals that are each used by a user; and one or more authentication servers. In the management system according to the present disclosure, a contract document, that is, contract content, of a contract newly concluded as a provisional contract is inspected, and the contract document adopted as a definitive contract according to the inspection result is stored into a ledger. Hereinafter, the configuration, etc., of the management system according to the present embodiment will be described with reference to the Drawings.

### [Management System]

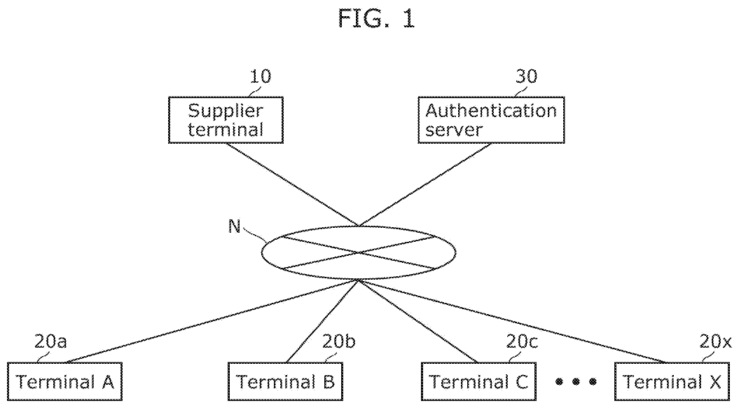

FIG. 1 is a diagram illustrating one example of the configuration of the management system according to Embodiment 1.

The management system according to the present embodiment includes supplier terminal 10, terminals 20a to 20x, and authentication server 30, for example, as illustrated in FIG. 1. These are connected by network N. Network N is, for example, the Internet or a mobile phone carrier network, but may include any communication line or network. In the following description, each of terminals 20a to 20x will also be referred to as terminal 20, and terminals 20a to 20x may also be referred to as terminals A to X.

Next, supplier terminal 10 will be described.

### [Supplier Terminal 10]

Supplier terminal 10, which is one example of the terminal that is used by a user, is a first terminal which is used by a first user who is one of two parties that have agreed to a first contract.

In the present embodiment, supplier terminal 10 is a terminal that is used by a supplier who is one user. Supplier terminal 10 may be a personal computer or may be a mobile device such as a smartphone and a tablet, for example. Note that the supplier may be a person who runs businesses such as an electricity business and a sharing service or may be an employee of such a company, for example. The first contract is, for example, one individual contract.

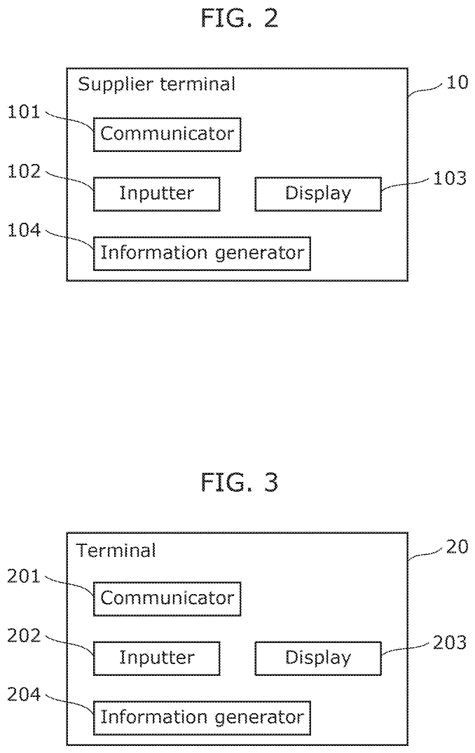

FIG. 2 is a diagram illustrating one example of the configuration of supplier terminal 10 according to Embodiment 1.

Supplier terminal 10 according to the present embodiment includes communicator 101, inputter 102, display 103, and information generator 104.

### <Communicator 101>

Communicator 101 transmits, to authentication server 30, first information generated by information generator 104. In the present embodiment, communicator 101 transmits information n1 to authentication server 30 via network N and receives a notification from authentication server 30 via network N, for example. Furthermore, communicator 101 transmits information to terminal 20 via network N and receives information from terminal 20 via network N, for example. Note that information n1 is one example of the first information and includes information A1, information B1, and the like, for example.

In this manner, communicator 101 communicates with terminals 20a to 20x or authentication server 30 via network N. Note that this communication may be performed using transport layer security (TLS) and an encryption key for TLS communication may be held in communicator 101.

### <Inputter 102>

Inputter 102 accepts information input entered by the supplier. Inputter 102 displays the accepted information input on display 103, transmits the accepted information input to information generator 104, and transmits the accepted information input to communicator 101, for example.

In the present embodiment, inputter 102 accepts contract document n of contract n agreed to with user n and entered by the supplier. Contract document n is one example of the first contract information which indicates the contract content of the first contract. Inputter 102 transmits, to information generator 104, contract document n of contract n accepted. Furthermore, inputter 102 accepts supplier input indicating that the notification displayed on display 103 has been checked. Note that contract document n of contract n includes, for example, contract document A of contract A and/or contract document B of contract B to be described below.

### <Display 103>

Display 103 displays the information input accepted by inputter 102. Display 103 displays information reported from authentication server 30.

### <Information Generator 104>

Information generator 104 generates first information including first contract information indicating the contract content of the first contract and a provisional contract flag indicating that the first contract information is a provisional contract.

In the present embodiment, information generator 104 generates information n1 including the provisional contract flag in addition to contract document n of contract n agreed to with user n and accepted by inputter 102. User n, who is the other of the two parties that have agreed to the first contract, is one example of the second user.

Information n1 includes time information, contract party ID, and the electronic signature of a person who has generated information n1, in addition to the contract information indicating contract document n and the provisional contract flag. The contract information, which is data indicating the contract content of contract n, may be data of contract document n or may be encrypted data of contract document n or may be hash values for specifying the contract content of contract document n. The time information may indicate the time at which information n1 is generated or may be the time at which contract n is concluded. Alternatively, the time information may indicate the time at which information n1 is transmitted from communicator 101 to authentication server 30. Note that the person who has generated information n1 herein is the first user, that is, the supplier. The contract party ID is ID of the second user who is the other of the two parties that have agreed to the first contract.

Next, terminals 20a to 20x will be described. Note that terminals 20a to 20x have the same configuration and thus will be referred to as terminal 20 in the following description.

### [Terminal 20]

Terminal 20 is one example of the terminal that is used by a user. Terminal 20 may be a personal computer or may be a mobile device such as a smartphone and a tablet, for example. One terminal 20 is the terminal that is used by the second user who is the other of the two parties that have agreed to the first contract. Furthermore, one terminal 20 is the second terminal that is used by an auditor who inspects the contract information indicating the contract content of contract n, namely, contract document n.

In the present embodiment, as one example, it is assumed that terminal 20c, that is, terminal C, among the plurality of terminals 20 is used by an auditor who inspects contract document A and contract document B. Terminal 20a, that is, terminal A, among the plurality of terminals 20 is used by the second user who is the other of the two parties that have agreed to contract A. Furthermore, assume that terminal 20b, that is, terminal B, is used by the second user who is the other of the two parties that have agreed to contract B.

FIG. 3 is a diagram illustrating one example of the configuration of terminal 20 according to Embodiment 1.

Terminal 20 according to the present embodiment includes communicator 201, inputter 202, display 203, and information generator 204.

### <Communicator 201>

Communicator 201 transmits information to authentication server 30 via network N and receives or is notified of information from authentication server 30 via network N, for example. Furthermore, communicator 201 transmits information to supplier terminal 10 or another terminal 20 via network N and receives information from supplier terminal 10 or another terminal 20 via network N, for example.

In this manner, communicator 201 communicates with supplier terminal 10, another terminal 20, or authentication server 30 via network N. Note that this communication may be performed using the TLS and an encryption key for TLS communication may be held in communicator 201.

More specifically, in the case where terminal 20 is the second terminal that is used by the auditor, communicator 201 receives the first contract information from authentication server 30. Communicator 201 transmits, to authentication server 30, a check result indicating approval or disapproval of the first contract information by the auditor. For example, assuming that terminal 20 is terminal C which is used by the auditor, communicator 201 receives, from authentication server 30, contract document n, namely, contract document A and contract document B. Contract document n is one example of the first contract information. Furthermore, communicator 201 transmits, to authentication server 30, a check result indicating approval or disapproval of each of contract document A and contract document B by the auditor.

### <Inputter 202>

Inputter 202 accepts information input entered by the user. Inputter 202 displays the accepted information input on display 203, transmits the accepted information input to information generator 204, and transmits the accepted information input to communicator 201, for example.

More specifically, in the case where terminal 20 is used by the auditor, inputter 202 accepts a check result entered by the auditor and indicating approval or disapproval of the first contract information by the auditor. Inputter 202 transmits the accepted check result to information generator 204. For example, assuming that terminal 20 is terminal C which is used by the auditor, inputter 202 accepts the check result entered by the auditor and indicating approval or disapproval of each of contract document A and contract document B by the auditor. Inputter 202 transmits, to information generator 204, the accepted check result for each of contract document A and contract document B.

### <Display 203>

Display 203 displays the information input accepted by inputter 202. Display 203 displays information transmitted from authentication server 30.

For example, in the case where terminal 20 is terminal C which is used by the auditor, display 203 displays the first contract information such as contract document A and contract document B transmitted from authentication server 30.

### <Information Generator 204>

Information generator 204 generates information of a check result indicating approval or disapproval of the first contract information by the auditor. For example, assuming that terminal 20 is terminal C which is used by the auditor, information generator 204 generates information indicating a check result on contract document A from the auditor and a check result on contract document B from the auditor.

Next, authentication server 30 will be described.

### [Authentication Server 30]

Authentication server 30 is one example of the first server.

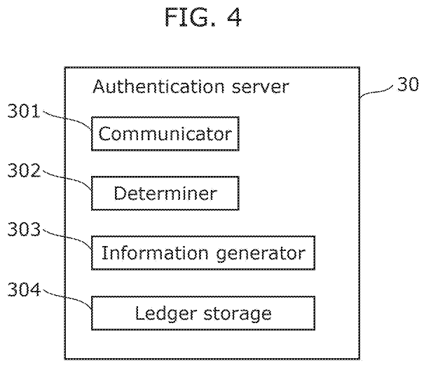

FIG. 4 is a diagram illustrating one example of the configuration of authentication server 30 according to Embodiment 1.

Authentication server 30 includes communicator 301, determiner 302, information generator 303, and ledger storage 304, as illustrated in FIG. 4. Authentication server 30 can be implemented by a processor executing a predetermined program using memory. The structural elements will be described below.

### <Communicator 301>

Communicator 301 receives, from the first terminal which is used by the first user who is one of the two parties that have agreed to the first contract, the first information including the first contract information indicating the contract content of the first contract and the provisional contract flag indicating that the first contract information is a provisional contract.

Communicator 301 transmits, to the second terminal which is used by the auditor determined by determiner 302, first contract information of the first information obtained from the ledger. Communicator 301 receives, from the second terminal, a check result indicating approval or disapproval of the first contract information by the auditor.

More specifically, communicator 301 receives, from supplier terminal 10 via network N, information n including contract document n indicating the contract content of contract n agreed to by the supplier and user n and a provisional contract flag indicating that contract document n is a provisional contract. Furthermore, communicator 301 transmits contract document n included in information n to terminal 20 that is used by the auditor determined by determiner 302 and receives, from said terminal 20, a check result indicating approval or disapproval of contract document n by the auditor, for example. Furthermore, communicator 301 notifies at least supplier terminal 10 that contract n has been adopted as a definitive contract.

In this manner, communicator 301 communicates with supplier terminal 10 or terminal 20 via network N. Note that this communication may be performed using the TLS and an encryption key for TLS communication may be held in communicator 301.

### <Determiner 302>

Determiner 302 determines whether a predetermined timing has come. The predetermined timing may be the point in time when the number of items of first contract information stored in the ledger reaches n (n is an integer greater than or equal to 1) or may be the point in time when a predetermined amount of time has elapsed. Alternatively, the predetermined timing may be the point in time when the number of persons who have concluded contracts with the supplier exceeds a threshold value or may be the point in time when the number of transactions of the service that the supplier provides exceeds a threshold value. As yet another alternative, the predetermined timing may be the point in time when a legal system about transactions of the service that the supplier provides changes.

Determiner 302 determines, at the predetermined timing, an auditor who inspects the first contract information. Determiner 302 may determine an auditor from among persons who concluded contracts after the first contract of the first contract information which is subject to inspection or may determine an auditor at random from a management contact list for managing information of users who receive the service that the supplier provides.

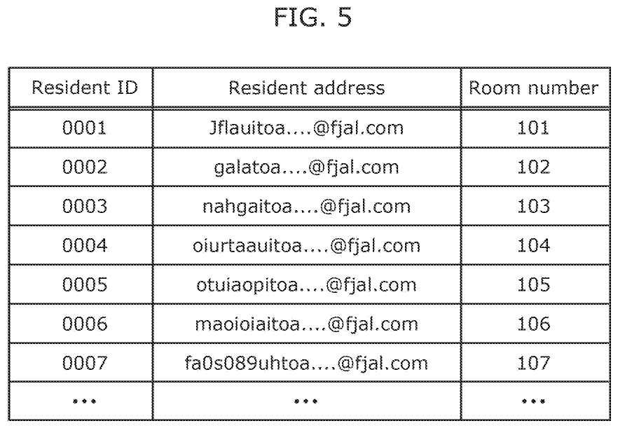

FIG. 5 is a diagram illustrating one example of the management contact list according to Embodiment 1. In the management contact list in the example illustrated in FIG. 5, the service that the supplier provides is electricity transaction, and users who receive the service that the supplier provides are residents of a condominium. This means that determiner 302 may determine an auditor at random from the management contact list illustrated in FIG. 5.

Furthermore, determiner 302 obtains the first contract information from the ledger. In the present embodiment, determiner 302 obtains contract document n of contract n from the ledger. For example, determiner 302 obtains contract document A of contract A and contract document B of contract B from the ledger in ledger storage 304.

Furthermore, determiner 302 checks the check result received by communicator 301 and determines whether the check result indicates approval of the first contract information. For example, determiner 302 checks the check result and determines whether the auditor has approved contract document A of contract A and whether the auditor has approved contract document B of contract B.

### <Information Generator 303>

When it is determined that the auditor has approved the first contract information, information generator 303 generates second information including the first contract information and a definitive contract flag indicating that the first contract information has been adopted as a definitive contract. The second information includes time information, contract party ID, the electronic signature of a person who has generated the first information, and the electronic signature of a person who has generated the second information, that is, the auditor, in addition to the contract information indicating contract document n and the definitive contract flag. The time information, the contract party ID, and the electronic signature of a person who has generated the first information are as described above and thus, description thereof will not be repeated.

More specifically, when determiner 302 determines that the auditor has approved contract document n, information generator 303 generates the second information including contract document n and the definitive contract flag indicating that the contract n with the contract document n has been adopted as a definitive contract.

Note that when determiner 302 determines that the auditor has not approved contract document n, information generator 303 may generate information to lead to a disapproval process. For example, information generator 303 may generate a change command to change the contract content of contract document n of contract n that has not been approved by the auditor. Here, information generator 303 may generate information that allows the person who has concluded the contract to present counter arguments, such as reasons of why the auditor has not approved, or may generate a condition on which the auditor will approve, in addition to the change command.

### <Ledger Storage 304>

In ledger storage 304, a ledger is stored. Ledger storage 304 stores, into the ledger, the first information including the first contract information and the provisional contract flag and received by communicator 301. Furthermore, ledger storage 304 obtains the second information generated by information generator 303 and stores the obtained second information into the ledger.

For example, information 1 including contract document A and the provisional contract flag and received by communicator 301 and information 2 including contract document B and the provisional contract flag and received by communicator 301 are stored in the ledger in ledger storage 304. Furthermore, information 1 generated by information generator 303 to include contract document A and the definitive contract flag and information 2 generated by information generator 304 to include contract document B and the definitive contract flag are stored in the ledger in ledger storage 304.

### [Operation, etc., of Management System]

Next, the operation of the management system configured as described above will be described.

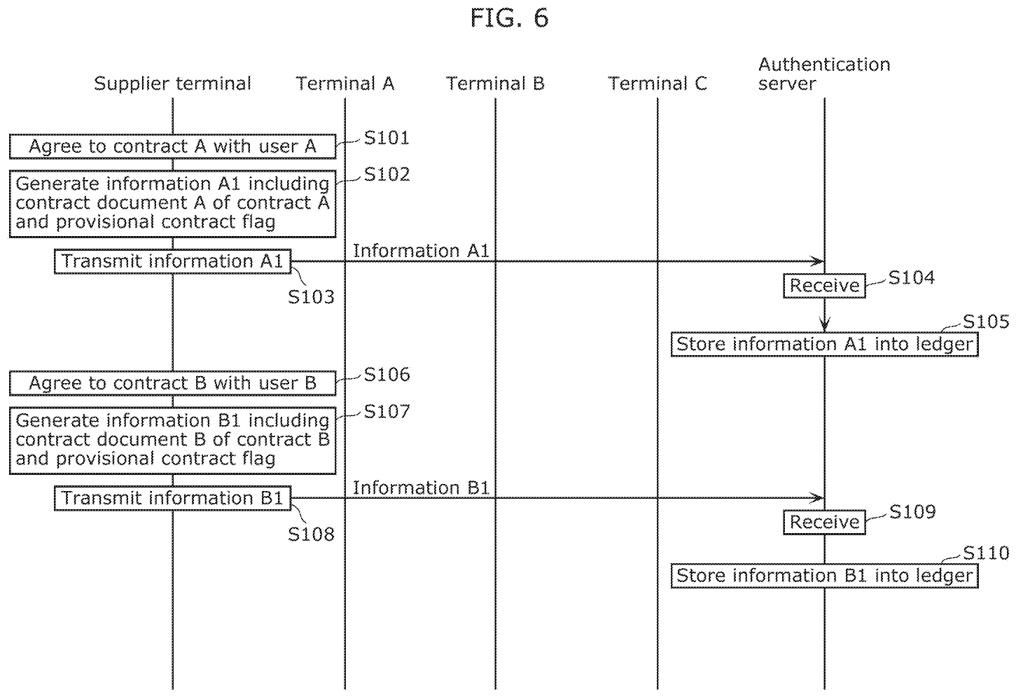

FIG. 6 to FIG. 8 are sequence diagrams illustrating the operation of the management system according to Embodiment 1.

First, assume that the supplier who uses supplier terminal 10 has agreed to contract A with user A (S101). Note that as described above, the supplier is one example of the first user who is one of the two parties that have agreed to contract A and user A is one example of the second user who is the other of the two parties.

Next, supplier terminal 10 generates information A1 including contract document A of contract A and the provisional contract flag according to supplier operation (S102). Note that as described above, information A1 includes the time information, the contract party ID indicating the second user, and the electronic signature of a person who has generated information A1, that is, the supplier, in addition to the data of contract document A and the provisional contract flag.

Next, supplier terminal 10 transmits, to authentication server 30, information A1 generated in Step S102 (S103).

Next, authentication server 30 receives information A1 transmitted in Step S103 (S104).

Next, authentication server 30 stores, into the ledger, information A1 received in Step S104 (S105).

Next, assume that the supplier who uses supplier terminal 10 has agreed to contract B with user B (S106). Note that the supplier is one example of the first user who is one of the two parties that have agreed to contract B and user B is one example of the second user who is the other of the two parties.

Next, supplier terminal 10 generates information B1 including contract document B of contract B and the provisional contract flag according to supplier operation (S107). Note that information B1 includes the time information, the contract party ID indicating the second user, and the electronic signature of a person who has generated information B1, that is, the supplier, in addition to the data of contract document B and the provisional contract flag.

Next, supplier terminal 10 transmits, to authentication server 30, information B1 generated in Step S107 (S108).

Next, authentication server 30 receives information B1 transmitted in Step S108 (S109).

Next, authentication server 30 stores, into the ledger, information B1 received in Step S109 (S110).

Next, authentication server 30 determines whether the predetermined timing has come (S111).

When authentication server 30 determines in Step S111 that the predetermined timing has not come (NO in S111), authentication server 30 returns to Step S111 to repeat the process.

On the other hand, when authentication server 30 determines in Step S111 that the predetermined timing has come (YES in S111), authentication server 30 determines an auditor (S112). For example, authentication server 30 determines an auditor at random from the management contact list such as that illustrated in FIG. 5.

Next, authentication server 30 obtains contract document n of contract n from the ledger (S113). In the example illustrated in FIG. 6, etc., authentication server 30 obtains contract document A of contract A and contract document B of contract B from the ledger.

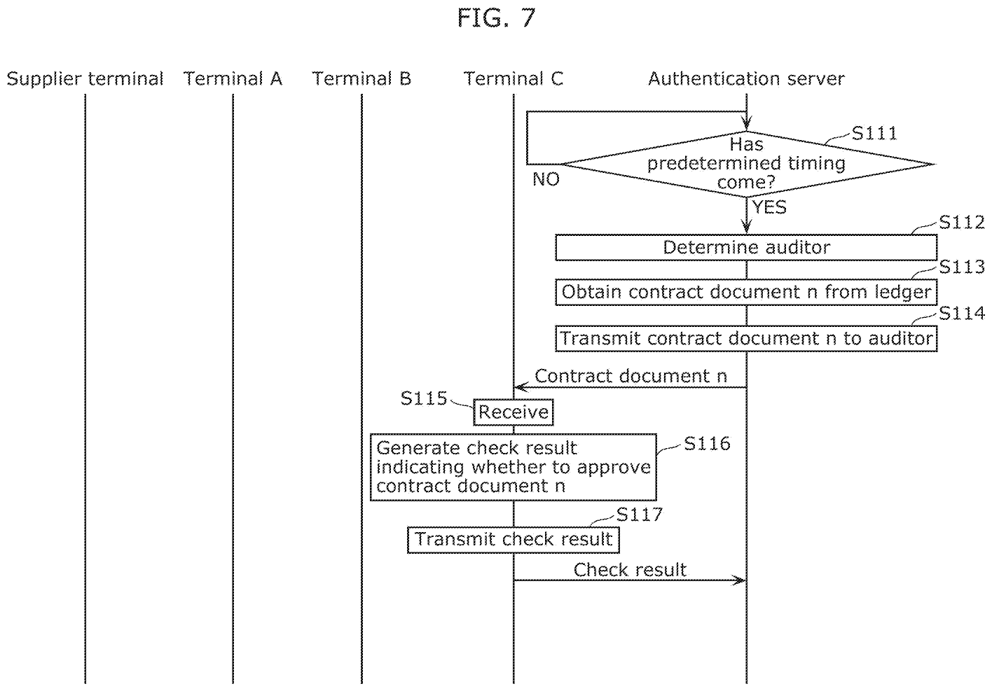

Next, authentication server 30 transmits contract document n obtained in S113 to terminal 20 that is used by the auditor determined in S112 (S114). In the example illustrated in FIG. 6 and FIG. 7, authentication server 30 transmits contract document A and contract document B to terminal C which is used by the auditor.

Next, terminal C receives contract document n transmitted in Step S114 (S115). In the example illustrated in FIG. 7, terminal C receives contract document A and contract document B from authentication server 30.

Next, according to the operation of the auditor, terminal C generates a check result indicating whether to approve contract document n (S116). In the example illustrated in FIG. 7, according to the operation of the auditor, terminal C generates a check result indicating whether to approve contract document A and a check result indicating whether to approve contract document B.

Next, terminal C transmits the check result generated in Step S116 to authentication server 30 (S117). In the example illustrated in FIG. 7, terminal C transmits, to authentication server 30, the check result indicating whether to approve contract document A and the check result indicating whether to approve contract document B.

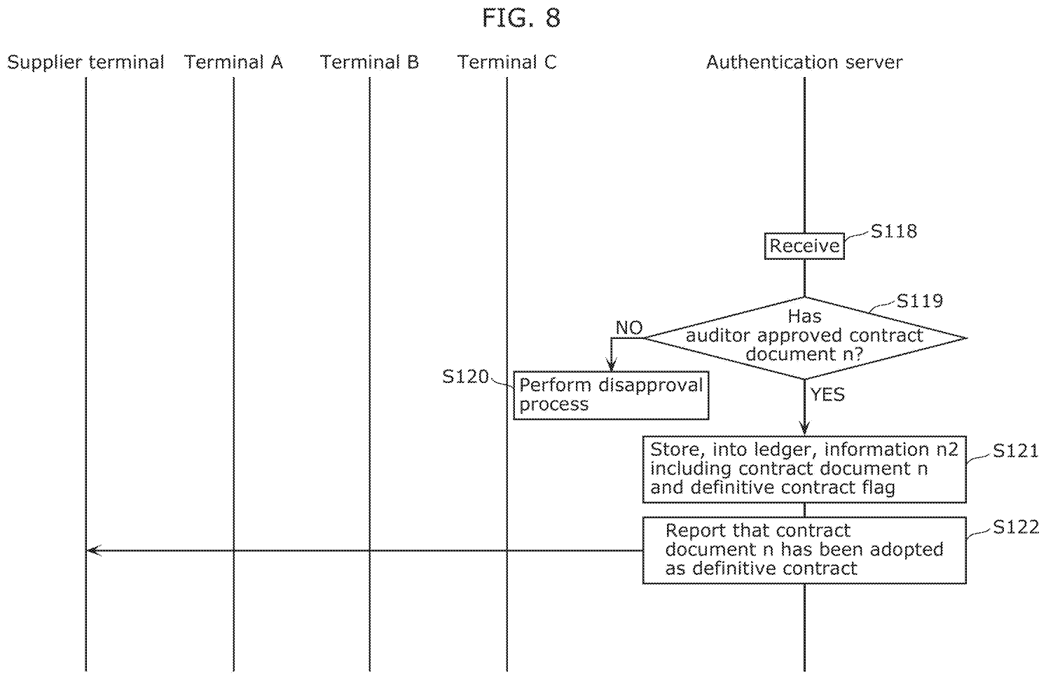

Next, authentication server 30 receives the check result transmitted in Step S117 (S118). In the example illustrated in FIG. 7 and FIG. 8, authentication server 30 receives the check result indicating whether to approve contract document A and the check result indicating whether to approve contract document B.

Next, authentication server 30 checks the check result received in Step S118 and determines whether the auditor has approved contract document n (S119). In the example illustrated in FIG. 8, authentication server 30 determines whether the auditor has approved contract document A and determines whether the auditor has approved contract document B.

When it is determined in Step S119 that the auditor has not approved contract document n (NO in S119), authentication server 30 performs the disapproval process (S120).

The disapproval process is a process for generating a change command to change the contract content of the contract document of the contract that has not been approved by the auditor. Note that the disapproval process may include a process for generating information that allows the person who has concluded the contract to present counter arguments, such as reasons of why the auditor has not approved, or may include a process for generating a condition on which the auditor will approve, in addition to the process for generating the change command. Furthermore, the disapproval process may include a process for sending, to the auditor, contract content modified by the person who concluded the contract that has not been approved. In this case, it is sufficient that the processing return to Step S114 and a modified contract document indicating the modified contract content be transmitted to the auditor. This allows at least the supplier who uses supplier terminal 10 to reconsider the contract that has not been approved by the auditor. Note that authentication server 30 may notify supplier terminal 10 that the auditor has not approved the contract document.

On the other hand, when it is determined in Step S119 that the auditor has approved contract document n (YES in S119), authentication server 30 stores information n2 including contract document n and the definitive contract flag into the ledger (S121). In the example illustrated in FIG. 6 to FIG. 8, when authentication server 30 determines that the auditor has approved contract document A and contract document B, authentication server 30 stores information A2 including contract document A and the definitive contract flag and information B2 including contract document B and the definitive contract flag into the ledger.

Next, authentication server 30 notifies at least supplier terminal 10 that contract n has been adopted as a definitive contract (S122). In the example illustrated in FIG. 6 to FIG. 8, authentication server 30 notifies supplier terminal 10 and terminal A that contract A with contract document A has been adopted as a definitive contract and notifies supplier terminal 10 and terminal B that contract B with contract document B has been adopted as a definitive contract.

In this manner, in the management system according to the present embodiment, the contract document of the contract newly concluded as a provisional contract can be subject to inspection by the auditor. Furthermore, the management system according to the present embodiment stores, into the ledger, the contract document of the contract adopted as a definitive contract according to the inspection result.

### Advantageous Effects, Etc

As described above, with the management system, etc., according to Embodiment 1, the contract newly concluded as a provisional contract can be subject to inspection by the auditor, and moreover the contract document of the contract adopted as a definitive contract according to the inspection result can be stored into the ledger.

Thus, the newly concluded contract can be reliably subject to inspection, meaning that it is possible to keep the supplier and the user from concluding a contract in collusion.

Note that the auditor who inspects the contract document of the newly concluded contract is described above as one person, but this is not limiting. The number of auditors who inspect the contract document may be any number greater than or equal to one.

Furthermore, supplier terminal 10 is described above as generating information n1 such as information A1 and information B1 and information n2, but this is not limiting. Terminal 20 that is used by the other of the two parties that have agreed to the first contract may generate information n1 and information n2.

### Embodiment 2

Embodiment 1 describes storing, into the ledger, the first information including the first contract information and the provisional contract flag and the second information which is a version of the first contract validated according to the inspection result, namely, the second information including the first contract information and the definitive contract flag. This ledger may be a distributed ledger in blockchain or may be a distributed ledger built on a blockchain platform and composed of a plurality of ledgers including identical content.

Embodiment 2 describes the case where authentication servers include a distributed ledger composed of a plurality of ledgers including identical content. Hereinafter, description will be carried out focusing on the difference from Embodiment 1.

### [Management System]

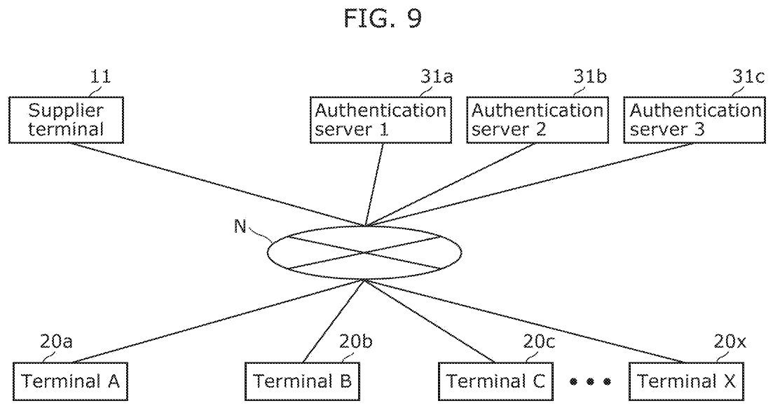

FIG. 9 is a diagram illustrating one example of the configuration of the management system according to Embodiment 2. Elements that are substantially the same as those in FIG. 1 are assigned the same reference signs and detailed description thereof will be omitted.

The management system illustrated in FIG. 9 differs from the management system according to Embodiment 1 in terms of the configuration of supplier terminal 11 and the configurations of authentication servers 31a to 31c. In the following description, each of authentication servers 31a to 31c will also be referred to as authentication server 31, and authentication servers 31a to 31c may also be referred to as authentication servers 1 to 3.

First, supplier terminal 11 will be described.

### [Supplier Terminal 11]

Supplier terminal 11 is one example of the terminal that is used by a user. Supplier terminal 11 is the first terminal which is used by the first user who is one of the two parties that have agreed to the first contract.

In the present embodiment as well, supplier terminal 11 is a terminal that is used by the supplier who is one user. Supplier terminal 11 may be a personal computer or may be a mobile device such as a smartphone and a tablet, for example.

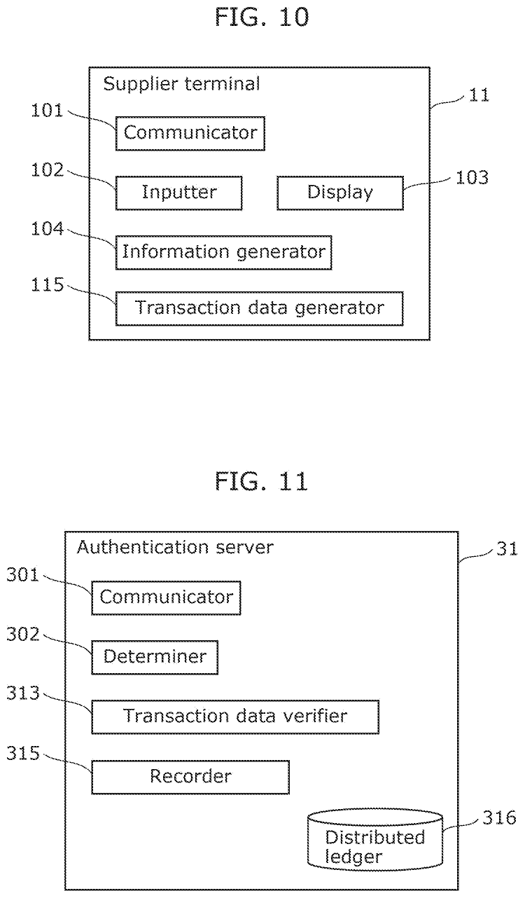

FIG. 10 is a diagram illustrating one example of the configuration of supplier terminal 11 according to Embodiment 2. Elements that are substantially the same as those in FIG. 2 are assigned the same reference signs and detailed description thereof will be omitted.

Supplier terminal 11 illustrated in FIG. 10 is different from supplier terminal 10 according to Embodiment 1 in that transaction data generator 115 is further included.

### <Communicator 101>

Communicator 101 may transmit, to authentication server 30, first transaction data generated by transaction data generator 115 to include the first information.

Note that in the case where the first transaction data is generated on the authentication server 30 side, communicator 101 may transmit the first information generated by information generator 104 to authentication server 30, as in Embodiment 1. The other features are as described in Embodiment 1 and thus, description thereof will not be repeated.

### <Information Generator 104>

Information generator 104 generates first information including first contract information indicating the contract content of the first contract and a provisional contract flag indicating that the first contract information is a provisional contract. Furthermore, information generator 104 generates second information including first contract information indicating the contract content of the first contract and a definitive contract flag indicating that the first contract information is a definitive contract.

The first information includes time information and contract party ID in addition to the contract information indicating contract document n and the provisional contract flag. The second information includes time information and contract party ID in addition to the contract information indicating contract document n and the definitive contract flag. Note that the first information and the second information may include a serial number indicating the order in which the first contract has been concluded. The other features are as described in Embodiment 1 and thus, description thereof will not be repeated.

### <Transaction Data Generator 115>

Transaction data generator 115 generates transaction data. More specifically, transaction data generator 115 may generate first transaction data including the first information. Transaction data generator 115 may generate second transaction data including the second information.

The first transaction data includes ID of the first transaction data (transaction data ID) and the electronic signature of a person who has generated the first transaction data, in addition to the first information, specifically, the contract information indicating contract document n, the provisional contract flag, the time information, and the contract party ID. Similarly, the second transaction data includes ID of the second transaction data (transaction data ID) and the electronic signature of a person who has generated the second transaction data, in addition to the second information, specifically, the contract information indicating contract document n, the definitive contract flag, the time information, and the contract party ID.

In the present embodiment, transaction data generator 115 generates transaction data n1 including information n1 generated by information generator 104. Information n1 includes contract document n of contract n and the provisional contract flag. Transaction data generator 115 generates transaction data n2 including information n2 generated by information generator 104. Information n1 includes contract document n of contract n and the definitive contract flag.

Transaction data generator 115 transmits generated transaction data n1 or transaction data n2 to authentication server 31 via communicator 101.

Next, authentication servers 31a to 31c will be described. Note that authentication servers 31a to 31c have the same configuration and thus will be referred to as authentication server 31 in the following description.

### [Authentication Server 31]

Authentication server 31 is one example of the first server.

FIG. 11 is a diagram illustrating one example of the configuration of authentication server 31 according to Embodiment 2. Elements that are substantially the same as those in FIG. 4 are assigned the same reference signs and detailed description thereof will be omitted.

Authentication server 31 illustrated in FIG. 11 is different in configuration from authentication server 30 according to Embodiment 1 in that information generator 303 and ledger storage 304 are not included, but transaction data verifier 313, recorder 315, and distributed ledger 316 are included. Authentication server 31 can be implemented by a processor executing a predetermined program using memory.

### <Communicator 301>

Communicator 301 receives the first transaction data including the first information from the first terminal which is used by the first user who is one of the two parties that have agreed to the first contract. The first information includes the first contract information indicating the contract content of the first contract and the provisional contract flag indicating that the first contract information is a provisional contract. Furthermore, communicator 301 obtains the second transaction data including the second information from the first terminal. The second information includes the first contract information and the definitive contract flag indicating that the first contract information has been adopted as a definitive contract.

Note that in the case where the first transaction data is generated on the authentication server 30 side, substantially the same processing as in Embodiment 1 will apply. Specifically, communicator 301 may receive the first information from the first terminal with no changes made to the first information.

In the case where transaction data verifier 313 executes a consensus algorithm, communicator 301 transfers the received first or second transaction data to another authentication server 31.

The other features are as described in Embodiment 1 and thus, description thereof will not be repeated.

### <Transaction Data Verifier 313>

When communicator 301 receives the first transaction data or the second transaction data, transaction data verifier 313 verifies the validity of the first transaction data or the second transaction data. For example, transaction data verifier 313 verifies whether the first or second transaction data received by communicator 301 includes an electronic signature generated by a proper method. Note that this verification may be skipped.

Furthermore, along with other authentication servers 31, transaction data verifier 313 executes a consensus algorithm for approving the validity of transaction data such as the first transaction data and the second transaction data.

As the consensus algorithm, a practical Byzantine fault tolerance (PBFT) may be used, or other known consensus algorithms may be used. Examples of the known consensus algorithms include proof of work (PoW) and proof of stake (PoS). In the case where the PBFT is used as the consensus algorithm, transaction data verifier 313 receives, from each of other authentication servers 31, a report indicating whether the verification of the transaction data has been successful, and determines whether the number of such reports exceeds a predetermined number. When the number of such reports exceeds the predetermined number, transaction data verifier 313 may determine that the validity of the transaction data has been verified by the consensus algorithm.

When transaction data verifier 313 confirms the validity of transaction data, transaction data verifier 313 causes recorder 315 to record the transaction data.

In the present embodiment, transaction data verifier 313 verifies the validity of transaction data n1 including information n1 and received by communicator 301 or transaction data n2 including information n2 and received by communicator 301.

Furthermore, transaction data verifier 313 executes a consensus algorithm for approving the validity of transaction data n1 or transaction data n2. Subsequently, when transaction data verifier 313 confirms the validity of transaction data n1 or transaction data n2, transaction data verifier 313 causes recorder 315 to record transaction data n1 or transaction data n2.

### <Recorder 315>

Recorder 315 includes, into a block, the first or second transaction data the validity of which has been verified by transaction data verifier 313, stores the block into distributed ledger 316, and thus records the first transaction data or the second transaction data. In the present embodiment, recorder 315 includes, into a block, transaction data n1 or n2 the validity of which has been verified by transaction data verifier 313, and stores the block into distributed ledger 316.

Note that distributed ledger 316 may be included in recorder 315.

### <Distributed Ledger 316>

The first transaction data and the second transaction data are stored in distributed ledger 316. In the present embodiment, distributed ledger 316 stores the first information and the second information by storing transaction data n1 or n2 the validity of which has been verified by transaction data verifier 313.

### [Operation, etc., of Management System]

Next, the operation of the management system configured as described above will be described.

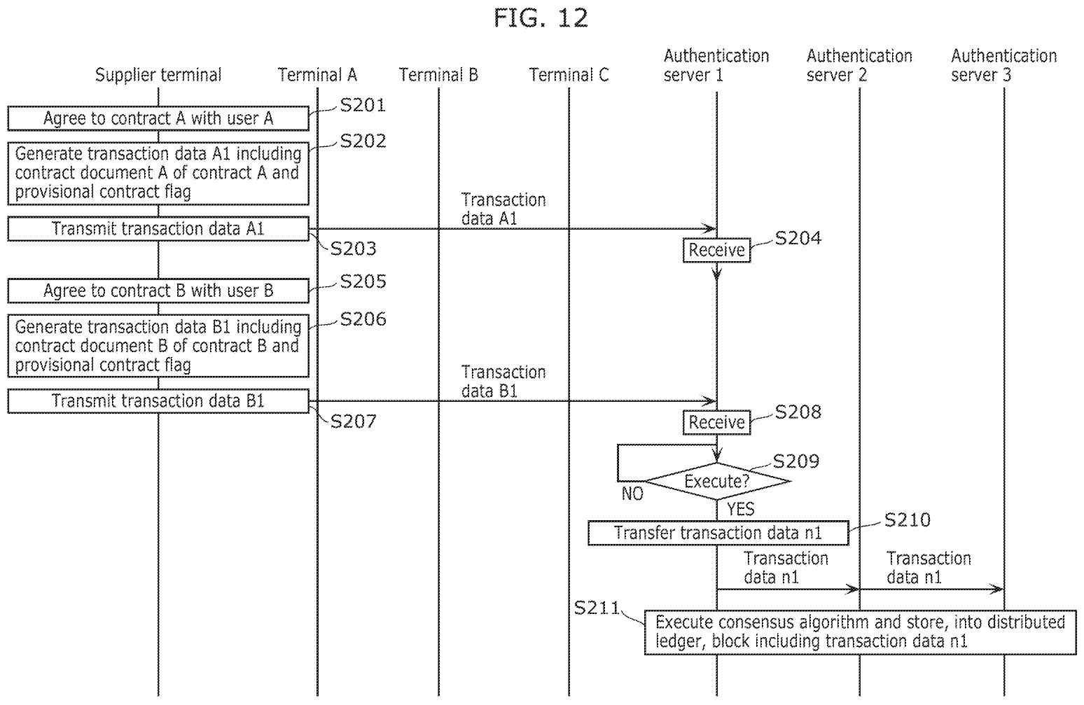

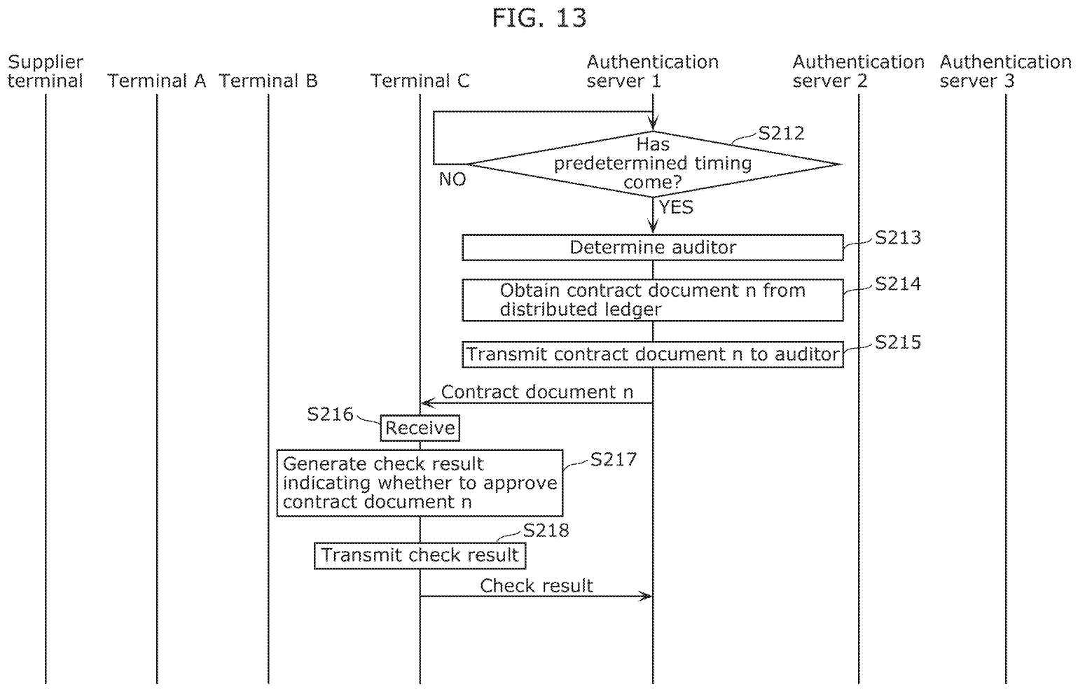

FIG. 12 to FIG. 14 are sequence diagrams illustrating the operation of the management system according to Embodiment 2.

First, assume that the supplier who uses supplier terminal 11 has agreed to contract A with user A (S201). Note that the supplier is one example of the first user who is one of the two parties that have agreed to contract A and user A is one example of the second user who is the other of the two parties.

Next, supplier terminal 11 generates transaction data A1 including contract document A of contract A and the provisional contract flag according to supplier operation (S202). In the present embodiment, supplier terminal 11 generates transaction data A1 including information A1. Information A1 includes the data of contract document A and the provisional contract flag.

Next, supplier terminal 11 transmits, to authentication server 1, transaction data A1 generated in Step S202 (S203).

Next, authentication server 1 receives transaction data A1 transmitted in Step S203 (S204).

Next, assume that the supplier who uses supplier terminal 11 has agreed to contract B with user B (S205). Note that as the supplier is one example of the first user who is one of the two parties that have agreed to contract B and user B is one example of the second user who is the other of the two parties.

Next, supplier terminal 11 generates transaction data B1 including contract document B of contract B and the provisional contract flag according to supplier operation (S206). In the present embodiment, supplier terminal 11 generates transaction data B1 including information B1. Information B1 includes the data of contract document B and the provisional contract flag.

Next, supplier terminal 11 transmits, to authentication server 1, transaction data B1 generated in Step S206 (S207).

Next, authentication server 1 receives transaction data B1 transmitted in Step S207 (S208).

Next, in the case where authentication server 1 executes a consensus algorithm for approving the validity of transaction data n1 (YES in S209), authentication server 1 transfers transaction data n1 to other authentication servers 31, specifically, authentication server 2 and authentication server 3 (S210). In the example illustrated in FIG. 12, authentication server 1 transfers transaction data A1 and B1 to authentication servers 2 and 3 as transaction data n1.

Next, authentication servers 1, 2, and 3 execute the consensus algorithm, generate blocks including transaction data n1, and store the blocks into distributed ledger 316 (S211).

In subsequent Steps S212 to S221, substantially the same processes as those in Steps S111 to S120 illustrated in FIG. 7 and FIG. 8 are performed although authentication server 30 is replaced by authentication server 1, which is the only difference; thus, description of Steps S212 to S221 will be omitted.

When it is determined in Step S220 that the auditor has approved contract document n (YES in S220), authentication server 1 notifies supplier terminal 11 that the auditor has approved contract document n (S222). In the example illustrated in FIG. 12 to FIG. 14, when authentication server 1 determines that the auditor has approved contract document A and contract document B, authentication server 1 notifies supplier terminal 11 that the auditor has approved contract document A and contract document B.

Next, when supplier terminal 11 obtains the notification transmitted in Step S222 and indicating that contract document n has been approved (S223), supplier terminal 11 generates transaction data n2 including contract document n of contract n and the definitive contract flag (S224). In the present embodiment, supplier terminal generates transaction data n2 including information n2.

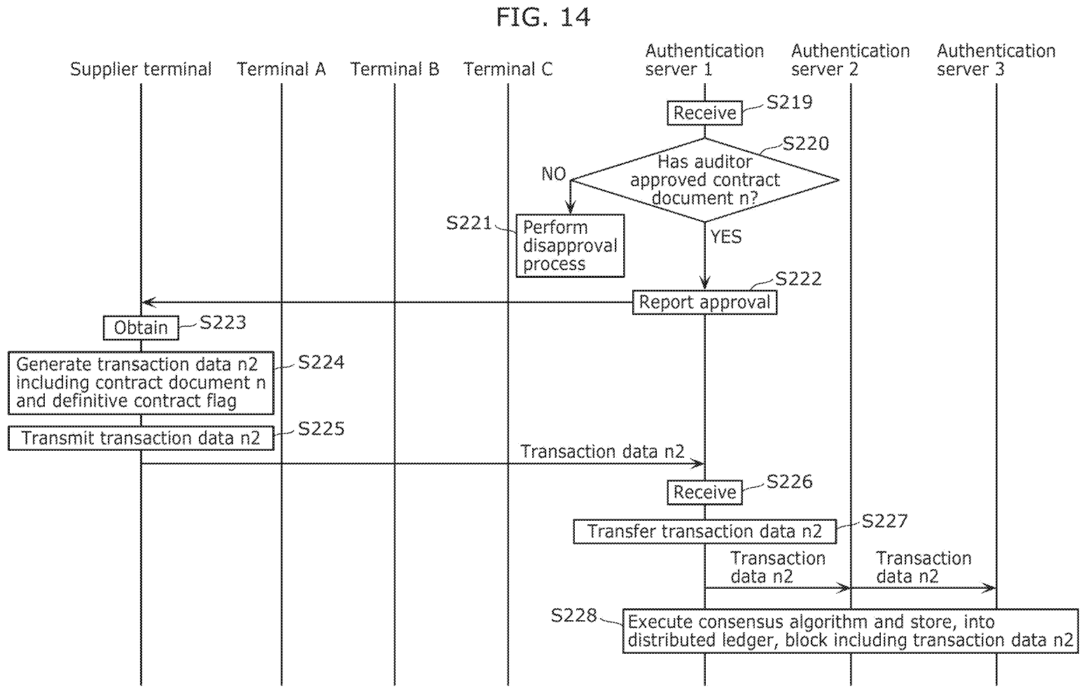

Information n2 includes the data of contract document n and the definitive contract flag. In the example illustrated in FIG. 14, supplier terminal 11 generates transaction data A2 including information A2, specifically, contract document A of contract A and the definitive contract flag and also generates transaction data B2 including information B2, specifically, contract document B of contract B and the definitive contract flag.

Next, supplier terminal 11 transmits, to authentication server 1, transaction data n2 generated in Step S224 (S225). In the example illustrated in FIG. 14, supplier terminal 11 transmits, to authentication server 1, transaction data A2 including contract document A of contract A and the definitive contract flag and transaction data B2 including contract document B of contract B and the definitive contract flag.

Next, authentication server 1 receives transaction data n2 transmitted in Step S225 (S226).

Next, authentication server 1 transfers transaction data n2 to other authentication servers 31, specifically, authentication server 2 and authentication server 3 (S227). In the example illustrated in FIG. 14, authentication server 1 transfers transaction data A2 and B2 to authentication servers 2 and 3 as transaction data n2.

Next, authentication servers 1, 2, and 3 execute the consensus algorithm, generate blocks including transaction data n2, and store the blocks into distributed ledger 316 (S228).

Note that transaction data n1 and transaction data n2 generated by supplier terminal 11 are transmitted to authentication server 1 in the example illustrated in FIG. 12 to FIG. 14, but may be transmitted to authentication server 2 or authentication server 3. The processing will be substantially the same.

Terminal C which is used by the auditor transmits, to authentication server 1, the result of checking contract document n transmitted to terminal C, but this is not limiting. Terminal C which is used by the auditor may generate transaction data including the result of checking contract document n transmitted to terminal C and transmit the transaction data to authentication server 1. In this case, the result of checking by the auditor is stored into the distributed ledger.

### Advantageous Effects, Etc

As described above, with the management system, etc., according to Embodiment 2, the contract newly concluded as a provisional contract can be subject to inspection by the auditor, and moreover the transaction data including the contract document of the contract adopted as a definitive contract according to the inspection result can be stored into the distributed ledger.

Thus, the newly concluded contract can be reliably subject to inspection, meaning that it is possible to keep the supplier and the user from concluding a contract in collusion. Furthermore, since the contract document of the contract inspected and adopted as a definitive contract is stored into the distributed ledger, it is possible to prevent future tampering with the newly concluded definitive contract. Thus, it is possible to more reliably keep the supplier and the user from concluding a contract in collusion.

Note that the auditor who inspects the contract document of the newly concluded contract is described above as one person, but this is not limiting. As described in Embodiment 1, the number of auditors who inspect the contract document may be any number greater than or equal to one.

Furthermore, supplier terminal 11 is described above as generating information n1, information n2, transaction data n1, and transaction data n2, but this is not limiting. Terminal 20 that is used by the other of the two parties that have agreed to the first contract may generate these information and data.

### Variations

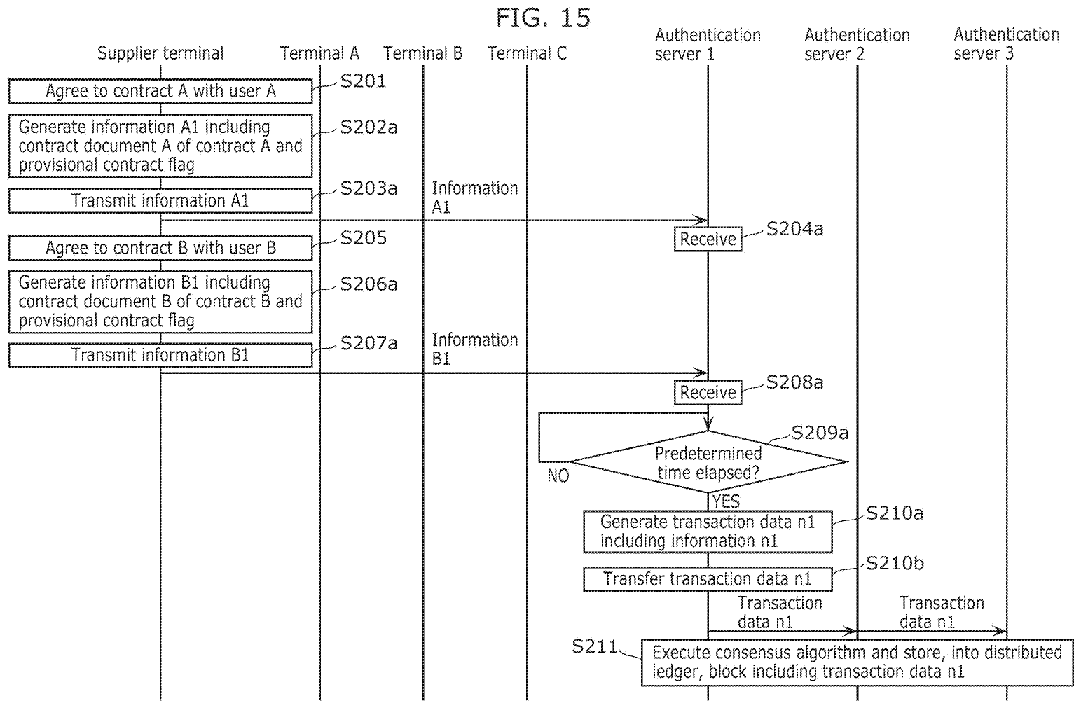

Note that in the operation of the management system illustrated in FIG. 12, the case where the transaction data is generated on the supplier terminal 11 side has been described, but this is not limiting. If authentication server 31 further includes the transaction data generator, the transaction data may be generated on the authentication server 31 side. The operation performed in this case will be described with reference to FIG. 15. Hereinafter, description will be carried out focusing on the difference from the above operation illustrated in FIG. 12.

FIG. 15 is a sequence diagram illustrating the operation of a management system according to a variation of Embodiment 2. Operation that is substantially the same as that in FIG. 12 is assigned the same reference sign and detailed description thereof will be omitted.

First, assume that the supplier who uses supplier terminal 11 has agreed to contract A with user A (S201).

Next, supplier terminal 11 generates information A1 including contract document A of contract A and the provisional contract flag according to supplier operation (S202a).

Next, supplier terminal 11 transmits, to authentication server 1, information A1 generated in Step S202a (S203a).

Next, authentication server 1 receives information A1 transmitted in Step S203a (S204a).

Next, assume that the supplier who uses supplier terminal 11 has agreed to contract B with user B (S205).

Next, supplier terminal 11 generates information B1 including contract document B of contract B and the provisional contract flag according to supplier operation (S206a).

Next, supplier terminal 11 transmits, to authentication server 1, information B1 generated in Step S206a (S207a).

Next, authentication server 1 receives information B1 transmitted in Step S207a (S208a).

Next, when a predetermined period has elapsed (YES in S209a), authentication server 1 generates transaction data n1 including information n1 (S210a). In the example illustrated in FIG. 15, authentication server 1 generates transaction data A1 including information A1 and transaction data B1 including information B1.

Next, authentication server 1 transfers transaction data n1 to other authentication servers 31, specifically, authentication server 2 and authentication server 3 (S210b).

Step S211 and the subsequent steps are as described above and thus, description thereof will not be repeated.

Note that transaction data n1 generated by supplier terminal 11 is transmitted to authentication server 1 in the example illustrated in FIG. 15, but may be transmitted to authentication server 2 or authentication server 3. The processing will be substantially the same.

### Embodiment 3

In Embodiment 2, transaction data n1 including the provisional contract flag and transaction data n2 including the definitive contract flag are described as being stored into the distributed ledger in the plurality of authentication servers 31 included in the management system, but this is not limiting. The management system does not need to include the authentication servers, but may instead include a plurality of terminals and a supplier terminal each of which includes a distributed ledger. In this case, transaction data n1 including the provisional contract flag and transaction data n2 including the definitive contract flag may be stored into the distributed ledger in each of the supplier terminal and the plurality of terminals. Hereinafter, description will be carried out focusing on the difference from Embodiment 1 and Embodiment 2.

### [Management System]

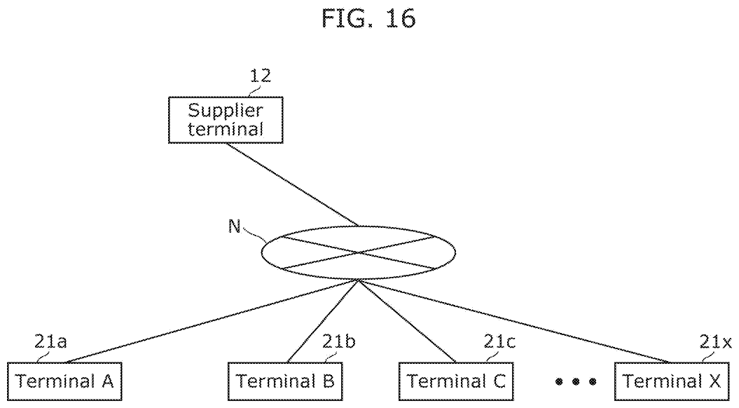

FIG. 16 is a diagram illustrating one example of the configuration of a management system according to Embodiment 3.

The management system illustrated in FIG. 16 is different from the management system according to Embodiment 2 in that the plurality of authentication servers 31 are not included, the supplier terminal has a different configuration as supplier terminal 12, and the terminals have different configurations as terminals 21a to 21x. In the following description, each of terminals 21a to 21x will also be referred to as terminal 21, and terminals 21a to 21x may also be referred to as terminals A to X.

First, supplier terminal 12 will be described.

### [Supplier Terminal 12]

Supplier terminal 12 is one example of the terminal that is used by a user, as with supplier terminal 11. Supplier terminal 12 is the first terminal which is used by the first user who is one of the two parties that have agreed to the first contract.

In the present embodiment as well, supplier terminal 12 is a terminal that is used by the supplier who is one user. Supplier terminal 12 may be a personal computer or may be a mobile device such as a smartphone and a tablet, for example.

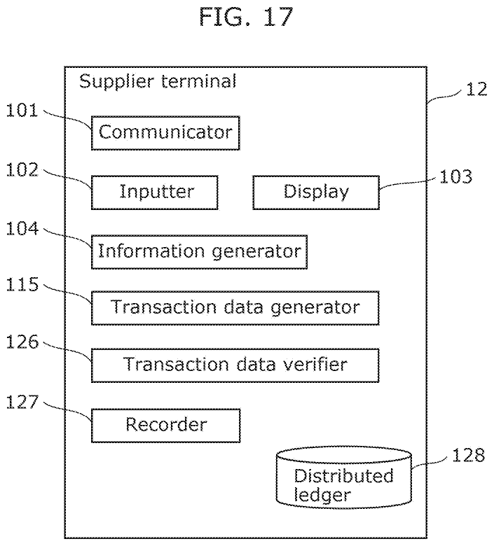

FIG. 17 is a diagram illustrating one example of the configuration of supplier terminal 12 according to Embodiment 3. Elements that are substantially the same as those in FIG. 2 and FIG. 10 are assigned the same reference signs and detailed description thereof will be omitted.

Supplier terminal 12 illustrated in FIG. 17 is different from supplier terminal 11 according to Embodiment 2 in that transaction data verifier 126, recorder 127, and distributed ledger 128 are further included.

### <Transaction Data Verifier 126>

When communicator 101 receives the first transaction data or the second transaction data, transaction data verifier 126 verifies the validity of the first transaction data or the second transaction data.

Note that this verification may be skipped.

Furthermore, along with other terminals 21, transaction data verifier 126 executes a consensus algorithm for approving the validity of the first transaction data or the second transaction data. When transaction data verifier 126 confirms the validity of the first transaction data or the second transaction data, transaction data verifier 126 causes recorder 127 to record the first transaction data or the second transaction data.

In the present embodiment, transaction data verifier 126 verifies the validity of transaction data n1 including information n1 or transaction data n2 including information n2.

Furthermore, transaction data verifier 126 executes a consensus algorithm for approving the validity of transaction data n1 including information n1 or transaction data n2 including information n2. Subsequently, when transaction data verifier 126 confirms the validity of transaction data n1 including information n1 or transaction data n2 including information n2, transaction data verifier 126 causes recorder 127 to record transaction data n1 including information n1 or transaction data n2 including information n2.

### <Recorder 127>

Recorder 127 includes, into a block, the first or second transaction data the validity of which has been verified by transaction data verifier 126, stores the block into distributed ledger 128, and thus records the first transaction data or the second transaction data. Note that distributed ledger 128 may be included in recorder 127.

### <Distributed Ledger 128>

The first transaction data or the second transaction data is stored in distributed ledger 128. In the present embodiment, distributed ledger 128 stores information n1 or information n2 by storing transaction data n1 including information n1 or transaction data n2 including information n2.

Next, terminals 21a to 21x will be described. Note that terminals 21a to 21x have the same configuration and thus will be referred to as terminal 21 in the following description.

### [Terminal 21]

Terminal 21 is one example of the terminal that is used by a user, as with terminal 20. Terminal 21 may be a personal computer or may be a mobile device capable of accessing the distributed ledger such as a smartphone and a tablet, for example. One terminal 21 is the terminal that is used by the second user who is the other of the two parties that have agreed to the first contract. Furthermore, one terminal 21 is the second terminal that is used by an auditor who inspects the contract information indicating the contract content of contract n, namely, contract document n.

In the present embodiment, as one example, it is assumed that among the plurality of terminals 21, terminal 21c, that is, terminal C, is used by the auditor. Furthermore, assume that among the plurality of terminals 21, terminal 21a, that is, terminal A, is used by the second user who is the other of the two parties that have agreed to contract A. Moreover, assume that terminal 21b, that is, terminal B, is used by the second user who is the other of the two parties that have agreed to contract B.

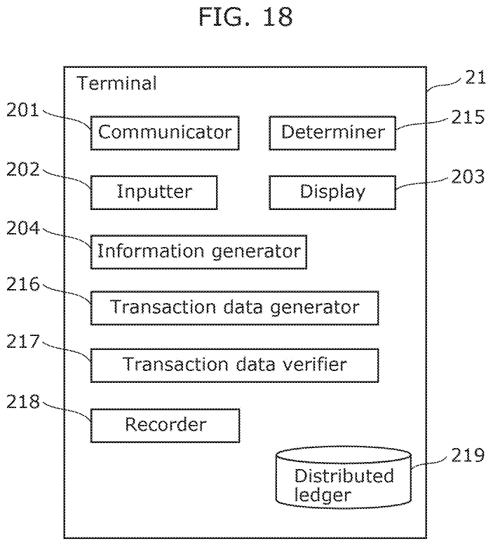

FIG. 18 is a diagram illustrating one example of the configuration of terminal 21 according to Embodiment 3. Elements that are substantially the same as those in FIG. 3 are assigned the same reference signs and detailed description thereof will be omitted.

Terminal 21 illustrated in FIG. 18 is different in configuration from terminal 20 according to Embodiment 1 in that determiner 215, transaction data generator 216, transaction data verifier 217, recorder 218, and distributed ledger 219 are further included.

### <Determiner 215>

Determiner 215 determines whether the predetermined timing has come. Determiner 215 determines, at the predetermined timing, an auditor who inspects the first contract information. Determiner 215 may determine an auditor from among persons who concluded contracts after the first contract of the first contract information which is subject to inspection or may determine an auditor at random from the management contact list for managing information of users who receive the service that the supplier provides.

Furthermore, determiner 215 obtains the first contract information from the distributed ledger. In the present embodiment, determiner 215 obtains contract document n of contract n from distributed ledger 219. For example, determiner 215 obtains contract document A of contract A and contract document B of contract B from transaction data A1 and transaction data B1 stored in distributed ledger 219.

Furthermore, determiner 215 checks the check result received by communicator 201 and determines whether the check result indicates approval of the first contract information. For example, determiner 215 checks the check result and determines whether the auditor has approved contract document A of contract A and whether the auditor has approved contract document B of contract B.

### <Transaction Data Generator 216>

Transaction data generator 216 generates the first transaction data or the second transaction data. More specifically, transaction data generator 216 may generate the first transaction data including the first information. Transaction data generator 216 may generate the second transaction data including the second information. Furthermore, transaction data generator 216 may transmit the generated first or second transaction data to another terminal 21, etc.

In the present embodiment, transaction data generator 216 generates transaction data n1 including information n1, specifically, contract document n and the provisional contract flag, and transaction data n2 including information n2, specifically, contract document n and the definitive contract flag.

Transaction data generator 216 transmits generated transaction data n1 or transaction data n2 to another terminal 21 or supplier terminal 12 via communicator 201.

### <Transaction Data Verifier 217>

When communicator 201 receives the first transaction data or the second transaction data, transaction data verifier 217 verifies the validity of the first transaction data or the second transaction data. Note that this verification may be skipped.

Furthermore, along with another terminal 21 and supplier terminal 12, transaction data verifier 217 executes a consensus algorithm for approving the validity of the first transaction data or the second transaction data. When transaction data verifier 217 confirms the validity of the first transaction data or the second transaction data, transaction data verifier 217 causes recorder 218 to record the first transaction data or the second transaction data.

In the present embodiment, transaction data verifier 217 verifies the validity of transaction data n1 including information n1 or transaction data n2 including information n2. Furthermore, transaction data verifier 217 executes a consensus algorithm for approving the validity of transaction data n1 including information n1 and transaction data n2 including information n2. When transaction data verifier 217 confirms the validity of transaction data n1 or n2, transaction data verifier 217 causes recorder 218 to record transaction data n1 or n2.

### <Recorder 218>

Recorder 218 includes, into a block, the first or second transaction data the validity of which has been verified by transaction data verifier 217, stores the block into distributed ledger 219, and thus records the first transaction data or the second transaction data.

Note that distributed ledger 219 may be included in recorder 218.

### <Distributed Ledger 219>

The first transaction data or the second transaction data is stored in distributed ledger 219. In the present embodiment, distributed ledger 219 stores information n1 or information n2 by storing transaction data n1 including information n1 or transaction data n2 including information n2.

### [Operation, etc., of Management System]

Next, the operation of the management system configured as described above will be described.

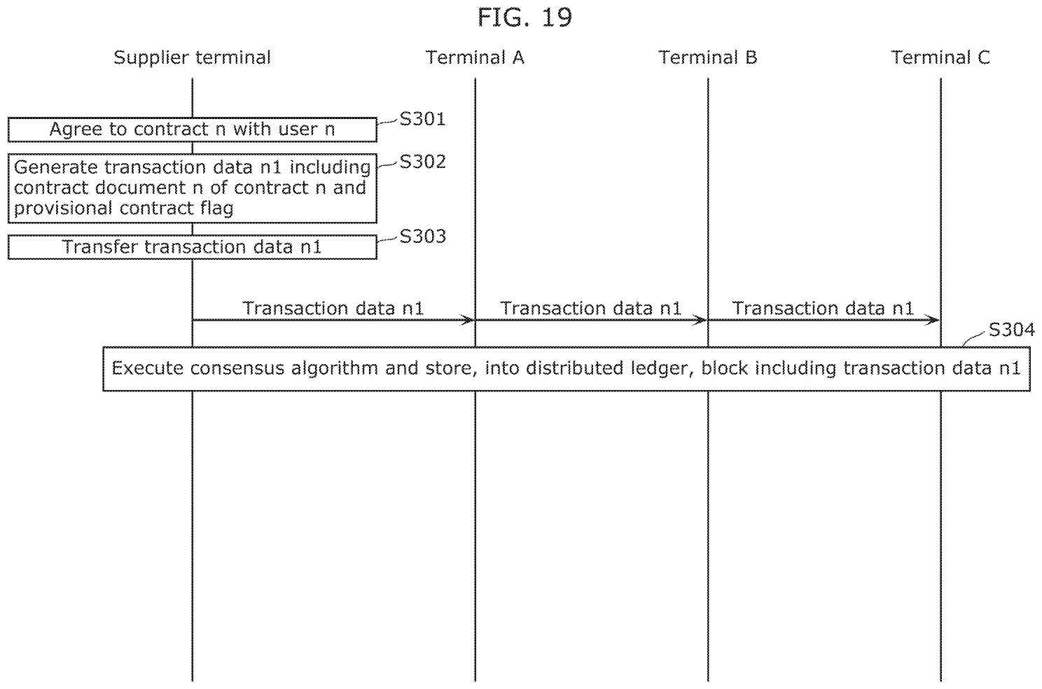

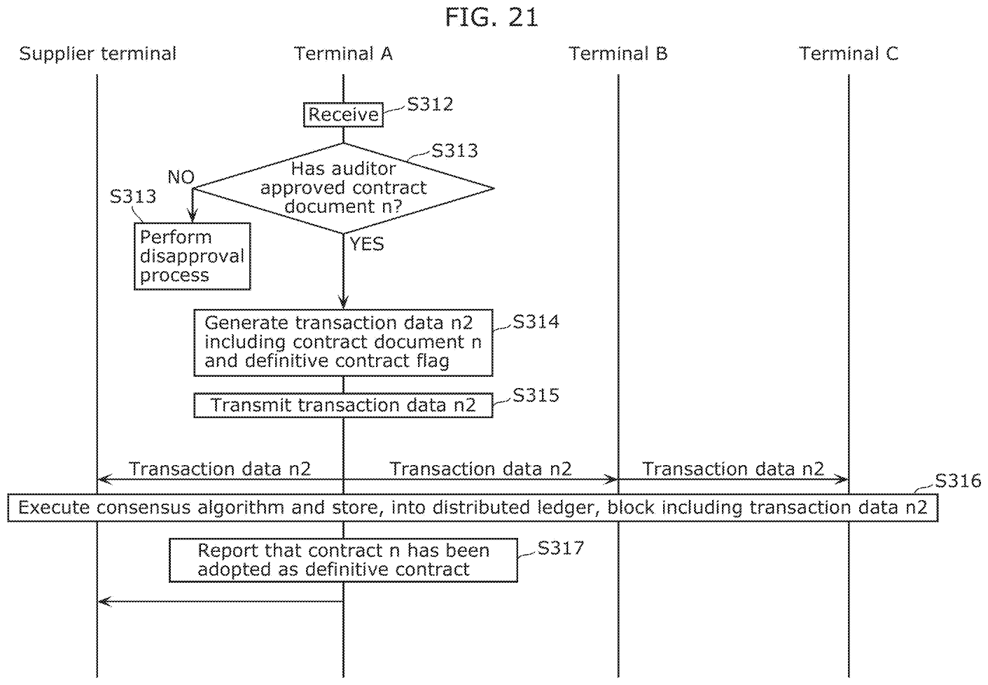

FIG. 19 to FIG. 21 are sequence diagrams illustrating the operation of the management system according to Embodiment 3.

First, assume that the supplier who uses supplier terminal 12 has agreed to contract n with user n (S301). Note that as described above, the supplier is one example of the first user who is one of the two parties that have agreed to the first contract and user n is one example of the third user who is the other of the two parties.

Next, supplier terminal 12 generates transaction data n1 including contract document n of contract n and the provisional contract flag according to supplier operation (S302).

Next, supplier terminal 12 transfers, to other terminals 21, specifically, terminals A, B, and C, transaction data n1 generated in Step S302 (S303).

Next, each of supplier terminal 12, terminal A, terminal B, and terminal C executes the consensus algorithm, generates a block including transaction data n1, and stores the block into the distributed ledger (S304).

Next, for example, terminal A determines whether the predetermined timing has come (S305). Note that this terminal, which is not limited to terminal A, may be terminal B as long as this terminal is terminal 21 that is used by the other party that has concluded the first contract. The processing will be substantially the same.

When terminal A determines in Step S305 that the predetermined timing has not come (NO in S305), terminal A returns to Step S305 and repeats the processing.

On the other hand, when terminal A determines in Step S305 that the predetermined timing has come (YES in S305), terminal A determines an auditor (S306). For example, terminal A determines an auditor at random from the management contact list such as that illustrated in FIG. 5.

Next, terminal A obtains contract document n of contract n from distributed ledger 219 (S307).

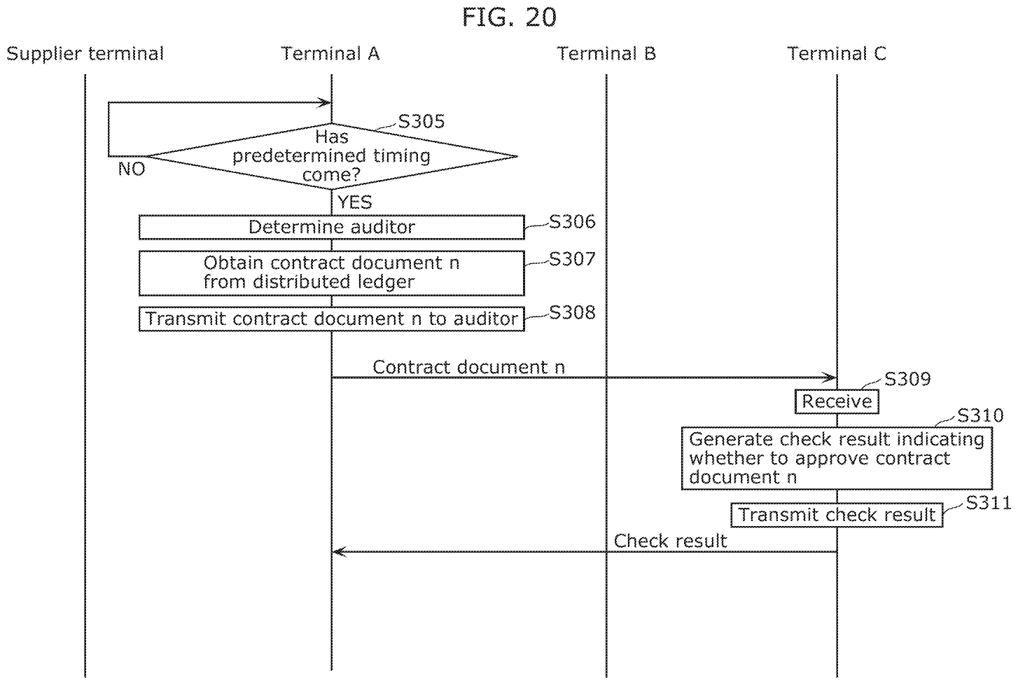

Next, terminal A transmits contract document n obtained in Step S307 to terminal 21 that is used by the auditor determined in Step S306 (S308). In the example illustrated in FIG. 20, terminal A transmits contract document n to terminal C which is used by the auditor.

Next, terminal C receives contract document n transmitted in Step S308 (S309).

Next, according to the operation of the auditor, terminal C generates a check result indicating whether to approve contract document n (S310).

Next, terminal C transmits the check result generated in Step S310 to terminal A (S311).

Next, terminal A receives the check result transmitted in Step S311 (S312).

Next, terminal A checks the check result received in Step S312 and determines whether the auditor has approved contract document n (S313).

When it is determined in Step S313 that the auditor has not approved contract document n (NO in S313), terminal A performs the disapproval process (S313). The disapproval process is as described in Step S120 and thus, description thereof will not be repeated here.

On the other hand, when it is determined in Step S313 that the auditor has approved contract document n (YES in S313), terminal A generates transaction data n2 including contract document n and the definitive contract flag (S314). In the present embodiment, terminal A generates transaction data n2 including information n2.

Information n2 includes the data of contract document n and the definitive contract flag.

Next, terminal A transfers transaction data n2 to other terminals 21, specifically, terminals B and C and supplier terminal 12 (S315).

Next, each of terminal A, terminal B, terminal C, and supplier terminal 12 executes the consensus algorithm, generates a block including transaction data n2, and stores the block into the corresponding distributed ledger (S316).

Lastly, terminal A notifies at least supplier terminal 12 that contract n has been adopted as a definitive contract (S317).

In this manner, in the management system according to the present embodiment, the contract of the contract newly concluded as a provisional contract can be subject to inspection by the auditor. Furthermore, the management system according to the present embodiment includes, into the transaction data, the contract document of the contract adopted as a definitive contract according to the inspection result, and stores the transaction data into the distributed ledger.

### Advantageous Effects, Etc

As described above, with the management system, etc., according to Embodiment 3, the contract newly concluded as a provisional contract can be subject to inspection by the auditor, and moreover the transaction data including the contract document of the contract adopted as a definitive contract according to the inspection result can be stored into the distributed ledger.

Thus, the newly concluded contract can be reliably subject to inspection, meaning that it is possible to keep the supplier and the user from concluding a contract in collusion. Furthermore, since the contract document of the contract inspected and adopted as a definitive contract is stored into the distributed ledger, it is possible to prevent future tampering with the newly concluded definitive contract. Thus, it is possible to more reliably keep the supplier and the user from concluding a contract in collusion.

Note that the auditor who inspects the contract document of the newly concluded contract is described above as one person, but this is not limiting. As described in Embodiment 1, the number of auditors who inspect the contract document may be any number greater than or equal to one.

Furthermore, supplier terminal 12 is described above as generating transaction data n1 and transaction data n2, but this is not limiting. One terminal 21 that is used by the other of the two parties that have agreed to the first contract may generate transaction data n1 and transaction data n2.

### Variation 1

Embodiment 3 has described the case where one of the plurality of terminals 21 such as terminal A determines an auditor who inspects the contract document of the contract newly concluded as a provisional contract and determines whether the auditor has approved said contract document, but this is not limiting. An agent server may determine an auditor who inspects the contract document of the contract newly concluded as a provisional contract and determine whether the auditor has approved said contract document.

The present variation will describe the case where agent server 40 determines an auditor and determines, from the check result, whether the auditor has approved the contract document. Furthermore, the present variation will describe that case where agent server 40, the plurality of terminals 21, and supplier terminal 12 include a distributed ledger composed of a plurality of ledgers including identical content. Hereinafter, description will be carried out focusing on the difference from Embodiment 1, etc.

### [Management System]

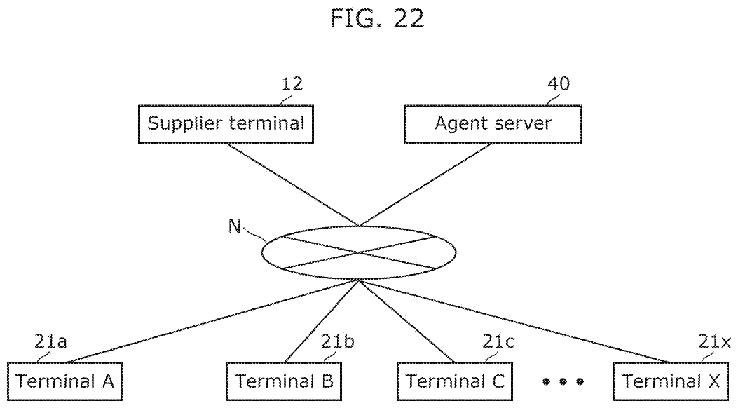

FIG. 22 is a diagram illustrating one example of the configuration of a management system according to Variation 1 of Embodiment 3. Elements that are substantially the same as those in FIG. 16 are assigned the same reference signs and detailed description thereof will be omitted.

The management system illustrated in FIG. 22 is different in configuration from the management system according to Embodiment 3 in that agent server 40 is further included. In the following description, each of terminals 21a to 21x will also be referred to as terminal 21, and terminals 21a to 21x may also be referred to as terminals A to X.

Next, agent server 40 will be described.

### [Agent Server 40]

Agent server 40 is one example of the first server.

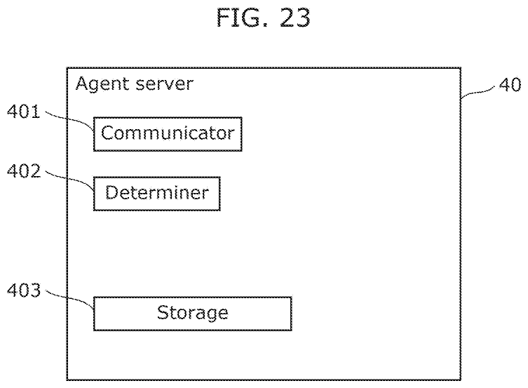

FIG. 23 is a diagram illustrating one example of the configuration of agent server 40 according to Variation 1 of Embodiment 3.

Agent server 40 includes communicator 401, determiner 402 and storage 403, as illustrated in FIG. 23. Agent server 40 can be implemented by a processor executing a predetermined program using memory. The structural elements will be described below.

### <Communicator 401>

Communicator 401 transmits, to the second terminal which is used by the auditor determined by determiner 402 to inspect the first contract information, the first contract information of the first information obtained from the distributed ledger. Communicator 401 receives, from the second terminal, a check result indicating approval or disapproval of the first contract information by the auditor.

In the present variation, communicator 401 transmits contract document n of information n to terminal 21 that is used by the auditor determined by determiner 402 to inspect contract document n, and receives, from terminal 21, the check result indicating approval or disapproval of contract document n by the auditor. Furthermore, communicator 401 notifies at least supplier terminal 12 that contract n has been adopted as a definitive contract.

In this manner, communicator 401 communicates with supplier terminal 12 or terminal 21 via network N. Note that this communication may be performed using the TLS and an encryption key for TLS communication may be held in communicator 401.

### <Determiner 402>

Determiner 402 determines whether the predetermined timing has come. Furthermore, determiner 402 determines, at the predetermined timing, an auditor who inspects the first contract information. Determiner 402 may determine an auditor from among persons who concluded contracts after the first contract of the first contract information which is subject to inspection or may determine an auditor at random from the management contact list for managing information of users who receive the service that the supplier provides.

Determiner 402 obtains the first contract information from the distributed ledger. In the present variation, determiner 402 obtains contract document n of contract n from the distributed ledger in terminal 21 or supplier terminal 12. For example, determiner 402 obtains contract document A of contract A and contract document B of contract from the distributed ledger in terminal 21 or supplier terminal 12.

Furthermore, determiner 402 checks the check result received by communicator 401 and determines whether the check result indicates approval of the first contract information. In the present variation, determiner 402 checks the check result received by communicator 401 and determines whether the auditor has approved contract document n of contract n. For example, determiner 402 checks the check result and determines whether the auditor has approved contract document A of contract A and whether the auditor has approved contract document B of contract B.

### <Storage 403>

Storage 403 stores the check result received by communicator 401 and stores the first contract information obtained from the distributed ledger in terminal 21 or supplier terminal 12. In the present variation, storage 403 stores contract document n of contract n as the first contract information.

### [Operation, Etc., of Management System]

Next, the operation of the management system configured as described above will be described.

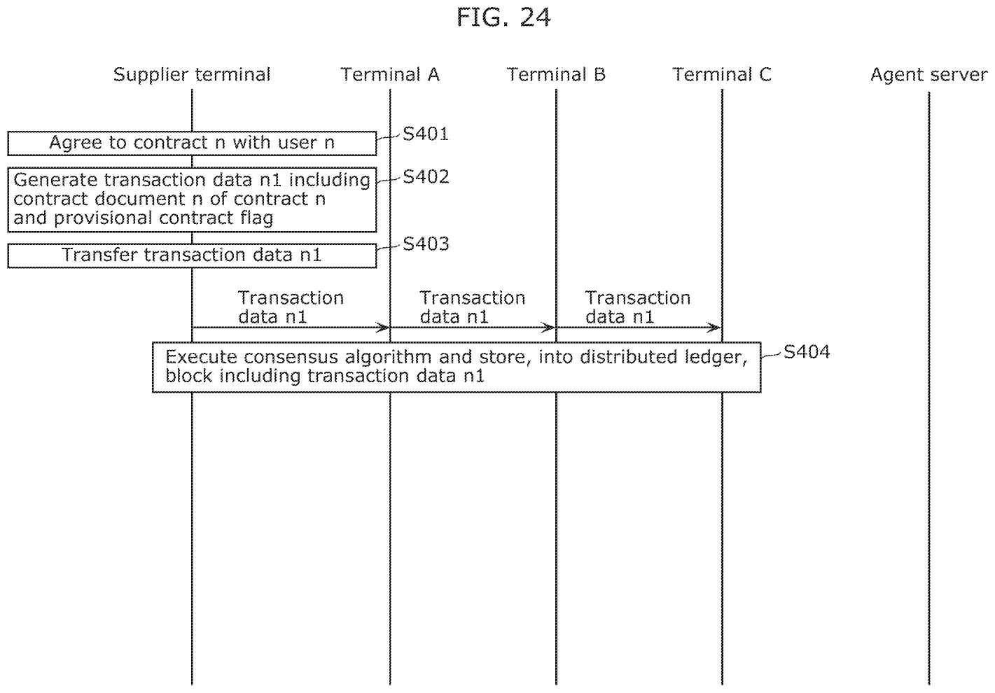

FIG. 24 to FIG. 26 are sequence diagrams illustrating the operation of the management system according to Variation 1 of Embodiment 3.

In Steps S401 to S404, substantially the same processes as those in Steps S301 to S304 illustrated in FIG. 19 are performed and thus, description of Steps S401 to S404 will be omitted.

Next, in Step S405, for example, agent server 40 determines whether the predetermined timing has come.

When agent server 40 determines in Step S405 that the predetermined timing has not come (NO in S405), agent server 40 returns to Step S405 to repeat the process.

On the other hand, when agent server 40 determines in Step S405 that the predetermined timing has come (YES in S405), agent server 40 determines an auditor (S406).

Next, agent server 40 obtains contract document n of contract n from the distributed ledger in terminal 21 or supplier terminal 12 (S407).

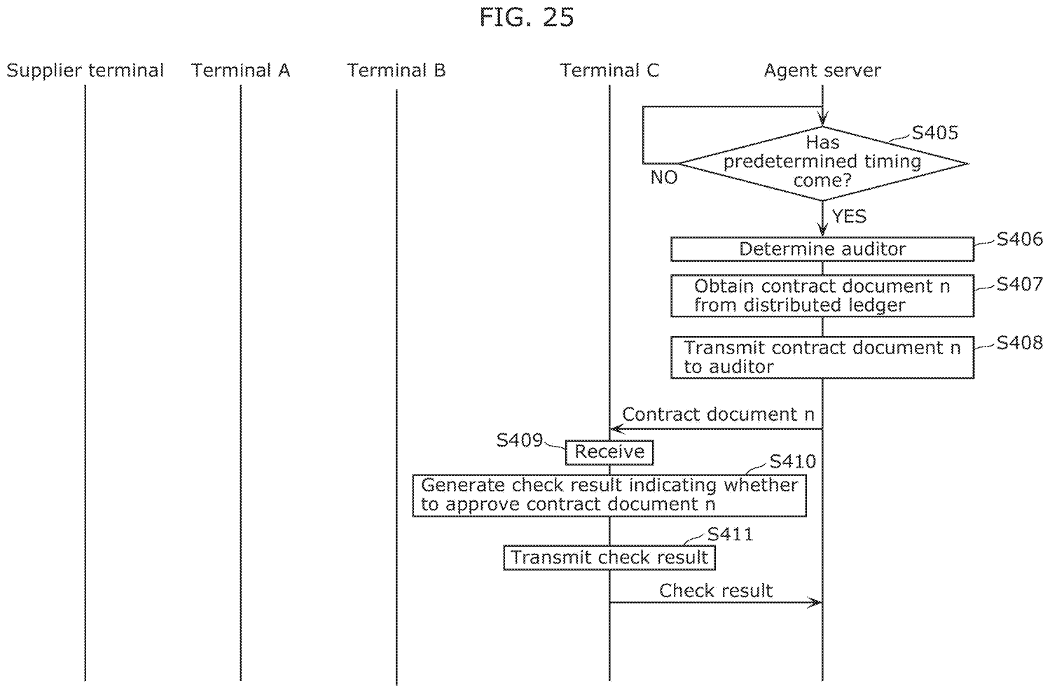

Next, agent server 40 transmits contract document n obtained in Step S407 to terminal 21 that is used by the auditor determined in Step S406 (S408). In the example illustrated in FIG. 25, agent server 40 transmits contract document n to terminal C which is used by the determined auditor.

Next, terminal C receives contract document n transmitted in Step S408 (S409).

Next, according to the operation of the auditor, terminal C generates a check result indicating whether to approve contract document n (S410).

Next, terminal C transmits, to agent server 40, the check result generated in Step S410 (S411).

Next, agent server 40 receives the check result transmitted in Step S411 (S412).

Next, agent server 40 checks the check result received in Step S412 and determines whether the auditor has approved contract document n (S413).

When it is determined in Step S413 that the auditor has not approved contract document n (NO in S413), agent server 40 performs the disapproval process (S414). The disapproval process is as described in Step S120 and thus, description thereof will not be repeated here.

On the other hand, when it is determined in Step S413 that the auditor has approved contract document n (YES in S413), agent server 40 notifies supplier terminal 12 that the auditor has approved contract document n (S415).

Next, when supplier terminal 12 obtains the notification transmitted in Step S415 and indicating that contract document n has been approved (S416), supplier terminal 12 generates transaction data n2 including contract document n of contract n and the definitive contract flag (S417). In the present variation, supplier terminal 12 generates transaction data n2 including information n2. Information n2 includes the data of contract document n and the definitive contract flag.

Next, supplier terminal 12 transfers, to terminals 21, specifically, terminals A, B, and C, transaction data n2 generated in Step S417 (S418).

Next, each of terminal A, terminal B, terminal C, and supplier terminal 12 executes the consensus algorithm, generates a block including transaction data n2, and stores the block into the corresponding distributed ledger (S419).

As described above, with the management system according to Variation 1 of the present embodiment, the contract newly concluded as a provisional contract can be subject to inspection by the auditor. Furthermore, the management system according to Variation 1 of the present embodiment includes, into the transaction data, the contract document of the contract adopted as a definitive contract according to the inspection result, and stores the transaction data into the distributed ledger.

### Variation 2

Variation 1 of Embodiment 3 has described the case where the plurality of terminals 21 and supplier terminal 12 include the distributed ledger composed of the plurality of ledgers including identical content and the agent server determines an auditor and determines whether the auditor has approved the contract document, but this is not limiting. The plurality of authentication servers may include a distributed ledger composed of the plurality of ledgers including identical content while the distributed ledger is not included in the plurality of terminal 21 or supplier terminal 12, and the agent server may determine an auditor and determine whether the auditor has approved the contract document. Hereinafter, this case will be described as Variation 2 of Embodiment 3, focusing on the difference from Variation 1, etc.

### [Management System]

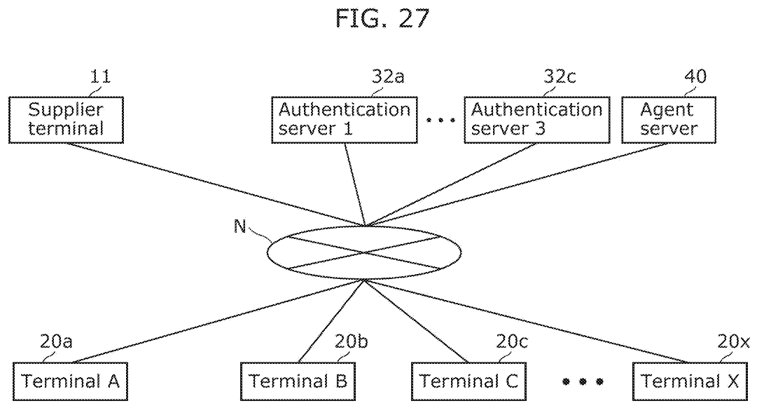

FIG. 27 is a diagram illustrating one example of the configuration of a management system according to Variation 2 of Embodiment 3. Elements that are substantially the same as those in FIG. 9 are assigned the same reference signs and detailed description thereof will be omitted.

The management system illustrated in FIG. 27 is different from the management system illustrated in FIG. 9 in that agent server 40 is further included and the authentication servers have different configurations as authentication servers 32a to 32c. Agent server 40 illustrated in FIG. 27 is as described in Variation 1 of Embodiment 3 and thus, description thereof will not be repeated here. In the following description, each of terminals 20a to 20x will also be referred to as terminal 20, and terminals 20a to 20x may also be referred to as terminals A to X. Furthermore, each of authentication servers 32a to 32c will also be referred to as authentication server 32, and authentication servers 32a to 32c may also be referred to as authentication servers 1 to 3.

First, authentication servers 32a to 32c will be described. Note that authentication servers 32a to 32c have the same configuration and thus will be referred to as authentication server 32 in the following description.

### [Authentication Server 32]

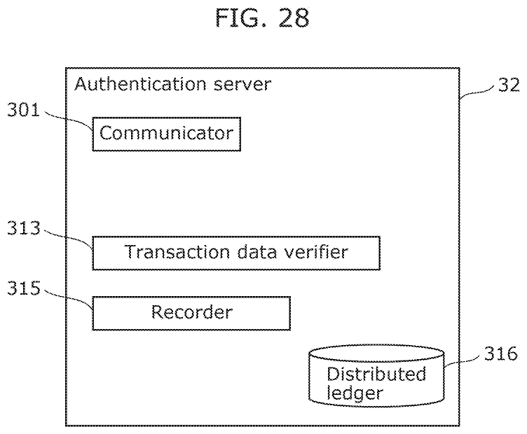

Authentication server 32 is one example of the first server. FIG. 28 is a diagram illustrating one example of the configuration of authentication server 32 according to Variation 2 of Embodiment 3. Elements that are substantially the same as those in FIG. 11 are assigned the same reference signs and detailed description thereof will be omitted.

Authentication server 32 illustrated in FIG. 28 is different from authentication server 31 according to Embodiment 2 in that the determiner is not included. Authentication server 32 can also be implemented by a processor executing a predetermined program using memory.

The other features are as described for authentication server 31 according to Embodiment 2 and thus, description thereof will not be repeated.

### [Operation, etc., of Management System]

Next, the operation of the management system configured as described above will be described.

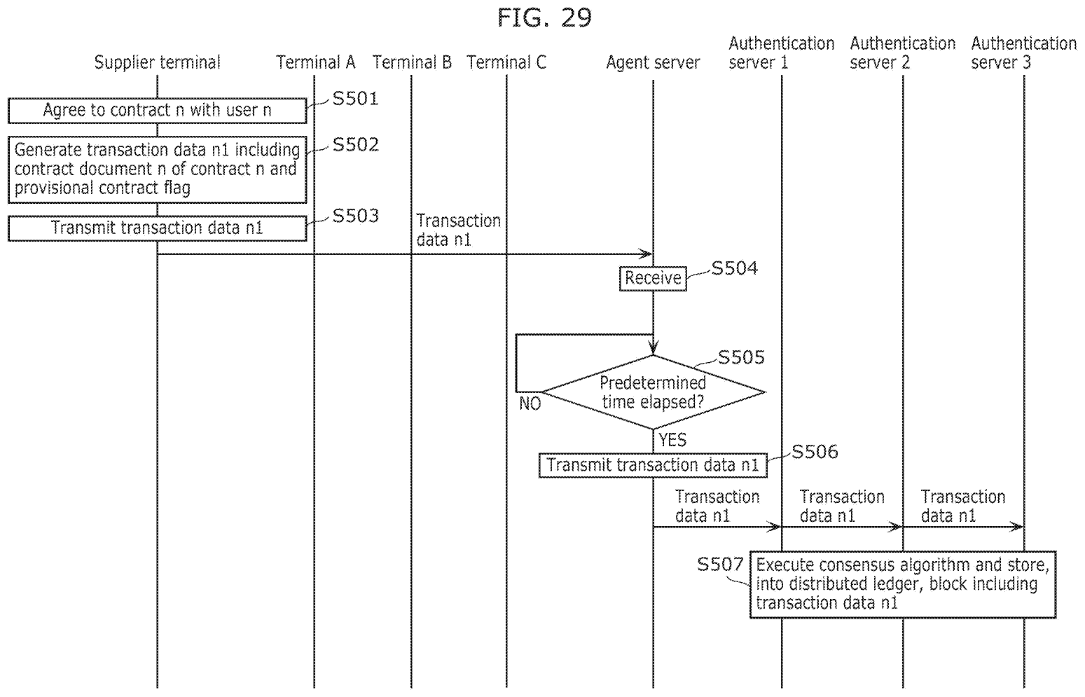

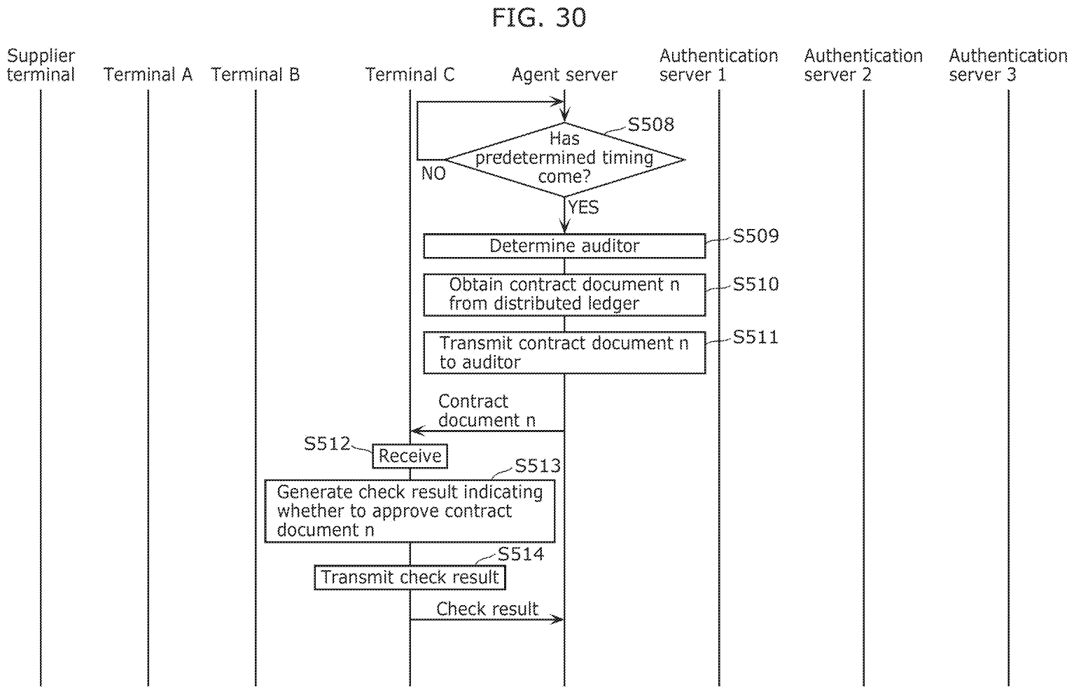

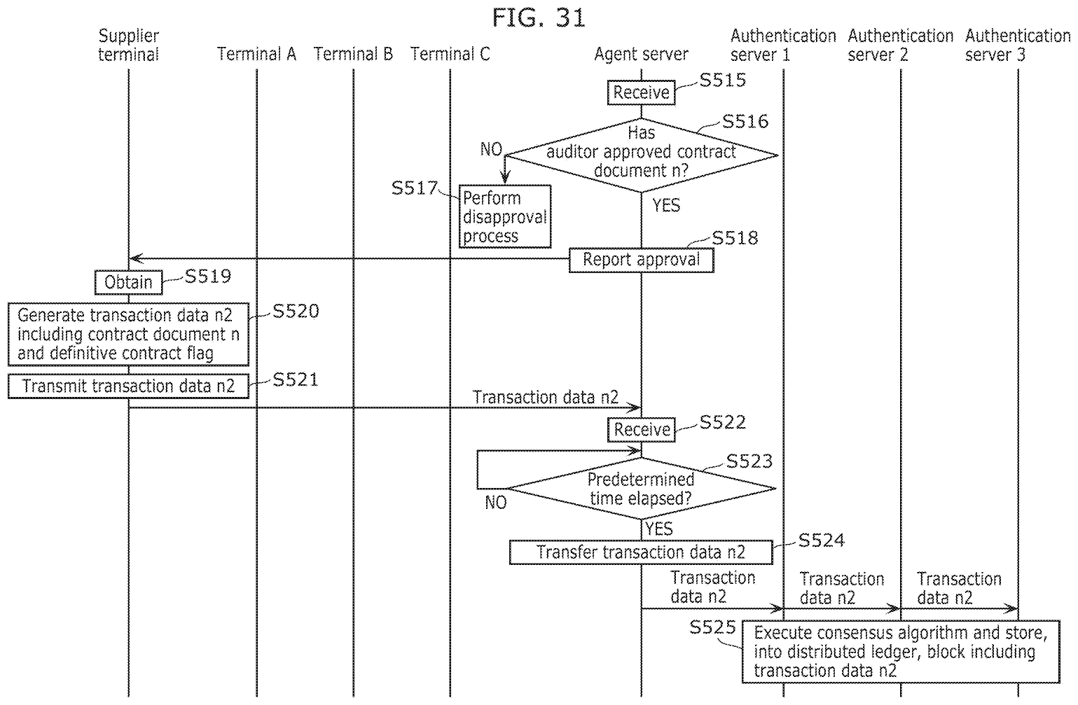

FIG. 29 to FIG. 31 are sequence diagrams illustrating the operation of the management system according to Variation 2 of Embodiment 3.

In Steps S501 and S502, substantially the same processes as those in Steps S301 and S302 illustrated in FIG. 19 are performed and thus, description of Steps S501 and S502 will be omitted.

Next, supplier terminal 11 transmits, to agent server 40, transaction data n1 generated in Step S502 (S503).

Next, agent server 40 receives transaction data n1 transmitted in Step S503 (S504).

Next, when a predetermined period has elapsed (YES in S505), agent server 40 transmits, to authentication servers 1 to 3, transaction data n1 received in Step S504 (S506).

Next, authentication servers 1, 2, and 3 execute the consensus algorithm, generate blocks including transaction data n1, and store the blocks into distributed ledger 316 (S507).

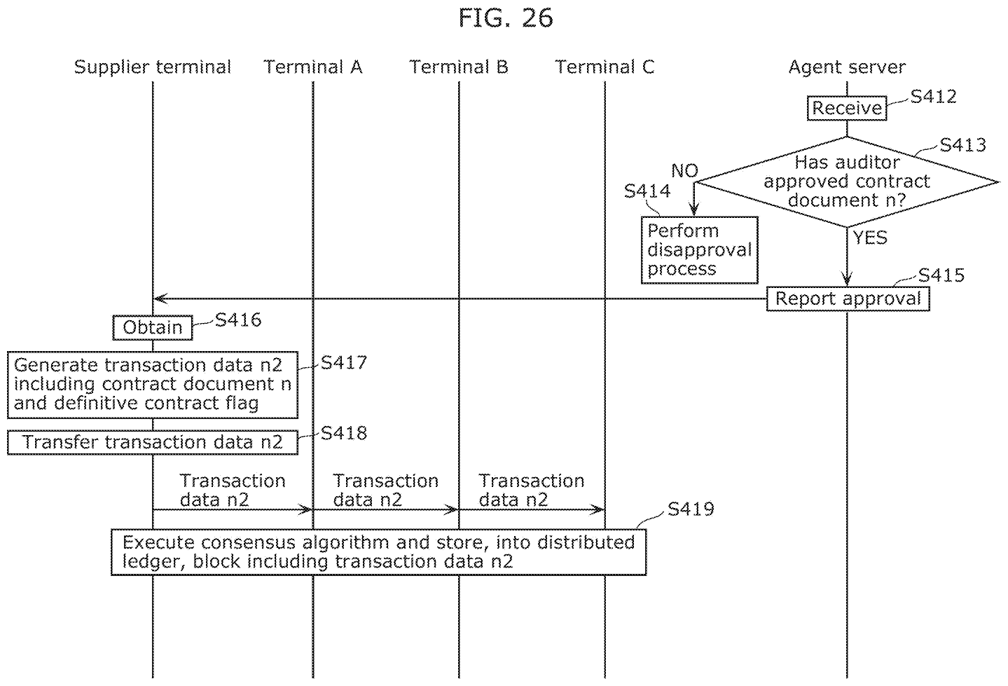

In subsequent Steps S508 to S520, substantially the same processes as those in Steps S405 to S416 illustrated in FIG. 25 and FIG. 26 are performed and thus, description of Steps S508 to S520 will be omitted.

Next, in Step S521, supplier terminal 11 transmits, to agent server 40, transaction data n2 generated in Step S520 (S521).

Next, agent server 40 receives transaction data n2 transmitted in Step S521 (S522).

Next, when a predetermined period has elapsed (YES in S523), agent server 40 transmits, to authentication servers 1 to 3, transaction data n2 received in Step S522 (S524).

Next, authentication servers 1, 2, and 3 execute the consensus algorithm, generate blocks including transaction data n2, and store the blocks into distributed ledger 316 (S525).

As described above, with the management system according to Variation 2 of the present embodiment, the contract newly concluded as a provisional contract can be subject to inspection by the auditor. Furthermore, the management system according to Variation 2 of the present embodiment includes, into the transaction data, the contract document of the contract adopted as a definitive contract according to the inspection result, and stores the transaction data into the distributed ledger.

As described above, with the management system according to Variation 2 of the present embodiment, the contract newly concluded as a provisional contract can be subject to inspection by the auditor. Furthermore, the management system according to Variation 2 of the present embodiment includes, into the transaction data, the contract document of the contract adopted as a definitive contract according to the inspection result, and stores the transaction data into the distributed ledger.

### Other Embodiments, Etc

The present disclosure has been described thus far based on the foregoing embodiments, but it goes without saying that the present disclosure is not limited to the foregoing embodiments. The present disclosure also includes such cases as described below.

(1) For example, in the present disclosure, the determined auditor may use a terminal in use to check the content of the contract document generated by the supplier terminal, and thus check that the first contract has not been tempered with.

(2) The foregoing embodiments have described determining, by the authentication server, the agent server, or the like, an auditor who inspects the contract document of the newly concluded contract, but this is not limiting. The authentication server, the agent server, and the like that determine an auditor may further include artificial intelligence (AI). In this case, the authentication server, the agent server, and the like may cause the AI to compare the contract document of the newly concluded contract and the contract document stored in the distributed ledger, thereby determining whether the contract content of the contract document stored in the distributed ledger is less advantageous than the contract document of the newly concluded contract.

(3) Each of the devices according to the foregoing embodiments is specifically a computer system configured of a microprocessor, read only memory (ROM), random access memory (RAM), a hard disk unit, a display unit, a keyboard, and a mouse, for example. A computer program is recorded on the RAM or the hard disk unit. Each of the devices achieves its function as a result of the microprocessor operating according to the computer program. Here, the computer program is configured of a combination of command codes indicating commands to the computer in order to achieve a predetermined function.

(4) Some or all of the structural elements included in each of the devices according to the foregoing embodiments may be configured from a single system Large Scale Integration (LSI). A system LSI is a super-multifunction LSI manufactured with a plurality of components integrated on a single chip, and is specifically a computer system configured of a microprocessor, ROM, and RAM, for example. A computer program is recorded on the RAM. The system LSI achieves its function as a result of the microprocessor operating according to the computer program.

Furthermore, each unit of the structural elements included in each of the devices described above may be individually configured into a single chip, or some or all of the units may be configured into a single chip.

Moreover, although a system LSI is mentioned here, the integrated circuit can also be called an IC, a LSI, a super LSI, and an ultra LSI, depending on the level of integration. Furthermore, the method of circuit integration is not limited to LSIs, and implementation through a dedicated circuit or a general-purpose processor is also possible. A field programmable gate array (FPGA) which allows programming after LSI manufacturing or a reconfigurable processor which allows reconfiguration of the connections and settings of the circuit cells inside the LSI may also be used.

In addition, depending on the emergence of circuit integration technology that replaces LSI due to progress in semiconductor technology or other derivative technology, it is obvious that such technology may be used to integrate the function blocks. Possibilities in this regard include the application of biotechnology and the like.

(5) Some or all of the structural elements included in each device described above may be implemented as a standalone module or an IC card that can be inserted into and removed from the device. The IC card or the module is a computer system made up of a microprocessor, ROM, RAM, and so on. The IC card or the module may include the aforementioned super multifunctional LSI. The IC card or the module achieves its functions by way of the microprocessor operating according to the computer program. The IC card and the module may be tamperproof.

(6) The present disclosure may be the above-described methods. Furthermore, the present disclosure may be a computer program for implementing these methods using a computer or may be a digital signal of the computer program.

Furthermore, the present disclosure may be a computer program or a digital signal recorded on a computer-readable recording medium, such as a flexible disk, a hard disk, a compact disc (CD-ROM), a magneto-optical disc (MO), a digital versatile disc (DVD), DVD-ROM, DVD-RAM, a Blu-ray (registered trademark) disc (BD), or a semiconductor memory, for example. The present disclosure may also be the digital signal recorded on these recoding media.

Furthermore, in the present disclosure, the computer program or the digital signal may be transmitted via an electrical communication line, a wireless or wired communication line, a network represented by the Internet, data broadcasting, or the like.

Furthermore, the present disclosure may be a computer system including a microprocessor and memory. The memory may have the computer program recorded therein, and the microprocessor may operate according to the computer program.

Moreover, by transferring the recording medium having the program or the digital signal recorded thereon or by transferring the program or the digital signal via the network or the like, the present disclosure may be implemented by a different independent computer system.

(7) The above embodiments and the above variations may be combined with each other.

### INDUSTRIAL APPLICABILITY

The present disclosure is applicable to control methods, servers, and recording media; for example, the present disclosure is applicable to a control method, a server, a recording medium, and the like by which, for example, at the time of concluding an individual contract between a supplier and a user in a car sharing service or the like, a newly concluded individual contract can be subject to inspection by an auditor.

1. A control method to be performed by a first server among one or more servers in a system including the one or more servers and three or more terminals each used by a user, the control method comprising:
receiving first information including first contract information and a provisional contract flag from a first terminal, the first contract information indicating contract content of a first contract, the provisional contract flag indicating that the first contract information is a provisional contract, the first terminal being used by a first user who is one of two parties that have agreed to the first contract;
storing, into a ledger, the first information received;
transmitting, to a second terminal used by an auditor who inspects the first contract information, the first contract information obtained from the ledger;
receiving, from the second terminal, a check result indicating approval or disapproval of the first contract information by the auditor; and
checking the check result, and when the check result indicates the approval of the first contract information, obtaining second information including the first contract information and a definitive contract flag, and storing the second information into the ledger, the definitive contract flag indicating that the first contract information has been adopted as a definitive contract.

2. The control method according to claim 1, wherein
the transmitting of the first contract information obtained from the ledger includes:
determining, at a predetermined timing, the auditor who inspects the first contract information; and
transmitting, to the second terminal used by the auditor determined, the first contract information obtained from the ledger.

3. The control method according to claim 1, wherein
the ledger is a distributed ledger built on a blockchain platform and composed of a plurality of ledgers including identical content.

4. The control method according to claim 3, wherein
the receiving of the first information includes:
receiving first transaction data including the first information to receive the first information,
the storing of the first information received, into the ledger, includes:
storing, into the ledger, a block including the first transaction data,
the obtaining of the second information includes:
obtaining second transaction data including the second information to obtain the second information, and
the storing of the second information obtained, into the ledger, includes:
storing, into the ledger, a block including the second transaction data.

5. The control method according to claim 4, wherein
the storing of the block including the first transaction data or the second transaction data into the ledger includes:
executing, along with a plurality of second servers among the one or more servers except the first server, a consensus algorithm for approving validity of the first transaction data or the second transaction data; and
storing, into the ledger, the block including the first transaction data or the second transaction data when the validity of the first transaction data or the second transaction data is approved by the consensus algorithm.

6. The control method according to claim 4, wherein
the storing of the block including the first transaction data or the second transaction data into the ledger includes:
storing the first transaction data or the second transaction data into the ledger as blockchain transaction data.

7. The control method according to claim 1, wherein
the first information includes:
in addition to the first contract information and the provisional contract flag,
time information;
an ID indicating a second user who is an other of the two parties that have agreed to the first contract; and
a signature of a person who has generated the first information.

8. A server that is one of one or more servers in a system including the one or more servers and three or more terminals each used by a user, the server comprising:
a processor; and
memory, wherein
the processor receives first information including first contract information and a provisional contract flag from a first terminal, the first contract information indicating contract content of a first contract, the provisional contract flag indicating that the first contract information is a provisional contract, the first terminal being used by a first user who is one of two parties that have agreed to the first contract,
the processor stores, into a ledger, the first information received,
the processor transmits, to a second terminal used by an auditor who inspects the first contract information, the first contract information obtained from the ledger,
the processor receives, from the second terminal, a check result indicating approval or disapproval of the first contract information by the auditor, and
the processor checks the check result, and when the check result indicates the approval of the first contract information, obtains second information including the first contract information and a definitive contract flag, and stores the second information into the ledger, the definitive contract flag indicating that the first contract information has been adopted as a definitive contract.

9. A non-transitory computer-readable recording medium having recorded thereon a program for causing a computer to execute a control method to be performed by a first server among one or more servers in a system including the one or more servers and three or more terminals each used by a user, the computer executing:
receiving first information including first contract information and a provisional contract flag from a first terminal, the first contract information indicating contract content of a first contract, the provisional contract flag indicating that the first contract information is a provisional contract, the first terminal being used by a first user who is one of two parties that have agreed to the first contract;
storing, into a ledger, the first information received;
transmitting, to a second terminal used by an auditor who inspects the first contract information, the first contract information obtained from the ledger;
receiving, from the second terminal, a check result indicating approval or disapproval of the first contract information by the auditor; and
checking the check result, and when the check result indicates the approval of the first contract information, obtaining second information including the first contract information and a definitive contract flag, and storing the second information into the ledger, the definitive contract flag indicating that the first contract information has been adopted as a definitive contract.
